(19) United States
(12) Patent Application Publication
(10) Pub. No.: US 2012/0290487 A1
(43) Pub. Date: Nov. 15, 2012

(54) EVALUATING INTELLECTUAL PROPERTY

(75) Inventors: Lewis C. Lee, Spokane, WA (US); John Anthony DeRosa, JR., Seattle, WA (US); John Charles Vogel, Mercer Island, WA (US); Ryan Glenn Roemer, Washington, DC (US); Chad Eberle, Seattle, WA (US)

(73) Assignee: IP Street, Spokane, WA (US)

(21) Appl. No.: 13/447,260

(22) Filed: Apr. 15, 2012

Related U.S. Application Data
(60) Provisional application No. 61/476,223, filed on Apr. 15, 2011.
(60) Provisional application No. 61/521,706, filed on Aug. 9, 2011.
(60) Provisional application No. 61/607,416, filed on Mar. 6, 2012.

(51) Int. Cl. G06Q 99/00

(52) U.S. Cl. 705/310

(57) ABSTRACT

Aggregation, analysis, and presentation of patent and business data in a common interface are described. The analysis includes techniques for evaluating a patent or patent application by examining claim-related information. These techniques include deriving unique signatures of individual claims and ascertaining scope of individual claims relative to other claims in a collection (such as claims found in a common class). The signature and scope of patent claims may be graphically depicted using various graphics elements in a user interface.

### RELATED APPLICATIONS

This application claims the benefit of U.S. Provisional Application No. 61/476,223, filed Apr. 15, 2011, U.S. Provisional Application No. 61/521,706, filed Aug. 9, 2011, and U.S. Provisional Application No. 61/607,426, filed Mar. 6, 2012, all of which are incorporated herein by reference.

This application is also related to U.S. patent application Ser. No. 12/730,098, filed Mar. 23, 2010, which claimed benefit to U.S. Provisional Application No. 61/162,998, filed Mar. 24, 2009. This application is also related to PCT Application No. PCT/US2008/78861, filed Oct. 3, 2008 and U.S. patent application Ser. No. 12/245,680, filed Oct. 3, 2008, both of which claim priority to U.S. Provisional Application No. 60/977,629, filed Oct. 4, 2007, and to U.S. Provisional Application No. 60/978,088, filed Oct. 5, 2007. All of these applications are hereby incorporated by reference.

### COPYRIGHT NOTICE

A portion of the disclosure of this patent document contains material to which a claim for copyright is made. The copyright owner has no objection to the facsimile reproduction by anyone of the patent document or the patent disclosure, as it appears in the Patent and Trademark Office patent file or records, but reserves all other copyright rights whatsoever.

### BACKGROUND

Innovation is a key factor for many companies to succeed in a globally competitive world. Protection of innovation via intellectual property (IP) helps those companies convert innovation into business assets. Today, intangible assets represent a significant share of the market capitalizations of many of the most successful and innovative companies. Yet, to the business community and many professionals who are not IP legal experts, intellectual property generally, and patents specifically, remain somewhat of a mystery to fully understand, assess, and value.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical items.

FIG. 1 shows an illustrative architecture for aggregating, analyzing, and presenting patent and business data.

FIG. 2 shows one example implementation of a server configuration and selected modules and components for implementing the architecture of FIG. 1.

FIG. 3 illustrates an example user interface rendered by a browser on a computer. The first screen rendering shows a project page with a menu of possible lenses.

FIG. 4 illustrates a keyword search user interface having a filter menu that enables users to enter various search terms.

FIG. 5 illustrates a results page presented in a list format from the keyword search input.

FIG. 6 illustrates a keyword relevance results page that shows in scatter plot format the results of a keyword search.

FIG. 7 shows a results page from a keyword search, wherein the results are organized according to a distribution presentation in a pie chart.

FIG. 8 shows the same user interface of FIG. 7, but also illustrates a drop down menu showing various ways to pivot the data results (e.g., by owner, inventor, law firm, examiner, class, subclass, or query).

FIG. 9 illustrates a results page from a keyword search and illustrates the data presented according to a portfolio layout.

FIG. 10 shows a results screen from a keyword search, in which the results are presented according to an accumulation trend layout showing the trend of asset creation/accumulation over time.

FIG. 11 illustrates a results screen from keyword search showing data presented in a growth rate trend that illustrates accumulation, velocity and acceleration components in the construction of a patent portfolio.

FIG. 12 illustrates a statistics screen that compares metrics of various patent portfolios.

FIG. 13 illustrates a portfolio page showing a taxonomy-based portfolio view of a patent portfolio of a company or a particular technology area.

FIG. 14 shows a second tier of the taxonomy-based portfolio layout in which assets are grouped according to a secondary classification (e.g., subclass) beneath the primary classification shown in FIG. 13.

FIG. 15 shows an inventor screen in which certain inventors (e.g., historically most prolific for a company/class/subclass, increased recent activity trend, most recent inventors for company/class/subclass, first time inventors for company/class/subclass, etc.) and their associated patents for a particular query are illustrated. The patents may be designated (e.g., color-coded, shaded, sized, shaped, etc.) to identify assignee and are arranged along a time axis to show when the assets were originally sought.

FIG. 16 illustrates a concept search results page in which results from a concept search engine are presented on a scatter plot having relevance plotted along one axis and time plotted along a second axis. The results may be designated (e.g., color-coded, shaded, sized, shaped, etc.) according to whether they are an issued patent or a patent application.

FIG. 17 illustrates a pivot screen that is achieved by choosing an option on a localized menu of the concept search result screen of FIG. 16. In this example, a distribution of owners of the results is shown as a pie graph.

FIG. 18 illustrates a view patent screen in which individual patents or applications may be viewed.

FIG. 19 illustrates a patent DNA screen in which graphical depictions of individual claim signatures and claim landscapes may be presented. FIG. 19 shows the claim landscape pane as a two dimensional graph in which one or more individual claims of a patent or patent application are plotted relative to other claims in a common technology area (e.g., class, subclass, industry segment, etc.).

FIG. 20 illustrates the claim landscape pane of FIG. 19, with an additional information (e.g., pop-up box, window, etc.) that appears when a user soft-selects (e.g., hovers a pointer over) a mark identifying a claim. The additional information contains all or part of the claim represented by the mark on the graph.

FIG. 21 shows a claim signature pane of the patent DNA screen, in which words and/or phrases that are unique to individual claims of a patent or application are graphically represented.

FIG. 22 illustrates the claim signature pane of FIG. 21, with additional information (e.g., pop-up box, window, etc.) that contains all or part of the represented claim.

FIG. 23 illustrates the claim signature pane of FIG. 21, with additional information (e.g., pop-up box, window, etc.) that shows word/phrase statistics for the word/phrase used in the represented claim.

FIG. 24 illustrates another implementation of the patent DNA screen having graphical depictions of individual claim signatures and claim landscapes.

FIG. 25 shows a graphical representation of results from a collection of analysis tools, some or all of which can be represented on a computer display or printed on a physical medium. The graphical representation contains several of the images and graphs discussed in this document, all generated for a common input, such as a patent number, owner, inventor, or the like.

FIG. 26 is a flowchart showing an example method of evaluating a patent and/or a patent application using a plurality of scoring algorithms.

FIG. 27 is a flowchart showing an example method of determining a scope metric of a claim of a patent or a patent application.

FIG. 28 is a flowchart showing an example method of performing a concept search for patents and/or patent applications flowchart based on a taxonomy selected from multiple available taxonomies.

FIG. 29 is a flowchart showing an example method of determining and analyzing a patent portfolio of a patent owner or assignee.

### DETAILED DESCRIPTION

Described herein is an architecture that aggregates patent and financial data, analyzes that data, and presents it in ways that are intuitive to non-IP professionals, such as inventors, product managers, executives, analysts, and financial professionals.

The architecture may be implemented in many ways. The following disclosure provides several illustrative examples, but they are merely examples and are not intended to be limiting.

### Example Architecture

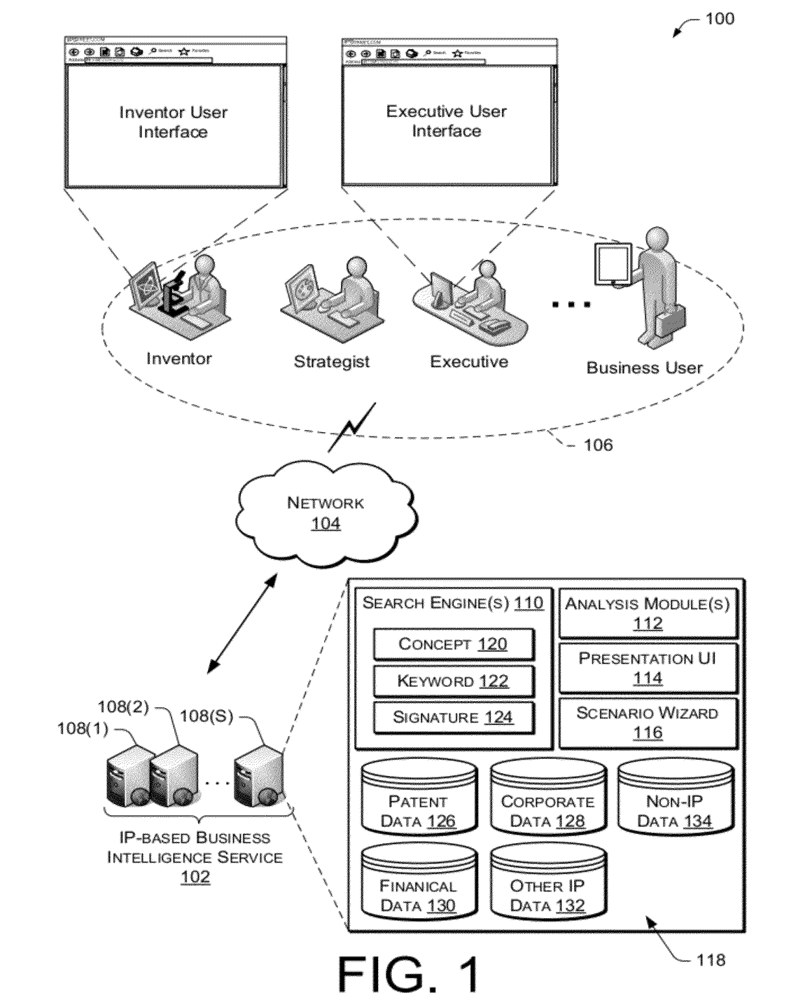

FIG. 1 shows an example architecture 100 for aggregating, analyzing, and presenting intellectual property and business data. The architecture 100 includes an IP-based business intelligence service 102 which aggregates patent, corporate, financial, and other IP data, analyzes that data, and serves that data over a network 104 to a community of users 106. Representative users include inventors, strategists, executives, and business users. Many other types of users may access the IP-based business intelligence service 102, including attorneys, accountants, investment bankers, venture capitalists, financial analysts, and so forth. The IP-based business intelligence service 102 may be implemented as a cloud service that is accessible over the internet. Cloud services do not require end user knowledge of the physical location or configuration of the system that delivers the services. Common names associated with cloud services include “software as a service” or “SaaS”, “platform computer”, “on-dash demand computing”, and so on. Any number of users 106 in the community may access the IP-based business intelligence service 102 at any time through browsers (e.g., Internet Explorer®, Firefox®, Safari®, Google Chrome®, etc.) resident on their local computing devices. Examples of the computing devices may include a server, a desktop PC (personal computer), a notebook or portable computer, a workstation, a mainframe computer, a handheld device, a netbook, an Internet appliance, a portable reading device, an electronic book reader device, a tablet or slate computer, a game console, a mobile device (e.g., a mobile phone, a personal digital assistant, a smart phone, etc.), or a combination thereof. Although browsers are a common form for accessing cloud services, other resident applications on the users' computing devices may be employed.

The network 104 may be a wireless or a wired network, or a combination thereof. The network 104 may be a collection of individual networks interconnected with each other and functioning as a single large network (e.g., the Internet or an intranet). Examples of such individual networks include, but are not limited to, telephone networks, cable networks, Local Area Networks (LANs), Wide Area Networks (WANs), and Metropolitan Area Networks (MANs). Further, the individual networks may be wireless or wired networks, or a combination thereof.

The IP-based intelligence service 102 may include processing capabilities, as represented by servers 108(1), 108(2), . . . , 108(s), which are collectively referred to as the server(s) 108. The servers 108 include both processing and storage capabilities. In one implementation, the IP-based business intelligence service 102 may host or provide a plurality of functional components including, for example, one or more search engines 110, one or more analysis modules 112, one or more presentation user interfaces 114, one or more scenario wizards 116, and one or more databases 118. Three search engines 110 including a concept search engine 120, a keyword search engine 122, and a claim signature search engine 124, are illustrated in FIG. 1, for example.

Representative databases 118 are illustrated in FIG. 1. The databases include a patent database 126, a corporate database 128, a financial database 130, and a database for other IP 132. The patent database 126 stores various patent documents, such as patent applications, granted patents, and file wrapper histories. The patent data from these various documents can be disaggregated and stored in various schemas to promote search efficiency and effectiveness. The corporate database 128 includes corporate data of various corporations and companies. The corporate data may include information such as number of employees, list of subsidiaries, functions or types of business, executive teams, corporate financial data (such as revenue, profits, etc.), and financial regulation filings. The financial database 130 may include information contained in financial markets, which may include, for example, stock price information, various metrics to measure a company's (e.g., P-E ratios, margin metrics, turnover ratios, etc.), and other data. The database 132 for other IP may include data surrounding other forms of intellectual property besides parents, such as trademarks, trade secrets, know-how and copyrights. In some implementations, the databases 118 may further include a database for non-IP data 134. The database 134 may include, for example, information of non-patent literature or documents, such as journal articles, conference articles, manuals, brochures, and other publications, etc. In one implementation, the information of a non-patent document included in the database 134 may include part (such as Title, Abstract, etc.) of the non-patent document. In some implementations, the information may include the entire data of the non-patent document. While in the illustrated example the databases are shown to be part of the IP-based business intelligence service 102, in other examples one or more of the databases may be separate from the IP-based business intelligence service 102 and may be administered by another entity.

As illustrated in FIG. 1, the users 106 may access the IP-based business intelligence service 102 via their computing devices and conduct any number of types of analysis related to intellectual property. Representative types of analysis are described in more detail below, and may include, for example, searching, validity, infringement, freedom-to-operate, licensing, inventorship review, benchmarking, competitive portfolio analysis, portfolio metrics, and scoring/ranking. As one example, an inventor may access the IP-based business intelligence service 102 to conduct patent searching with respect to the patentability of an idea and receive various results pertaining to that patentability search. Simultaneously, an executive may review a competitor's portfolio for benchmarking purposes, access the IP-based business intelligence service 102 and see results pertaining to that review. In another example, a strategist may evaluate licensing opportunities, while another business user may ascertain the quality of a patent using one or more scoring tools provided by the IP-based business intelligence service 102. These and numerous other uses of the IP-based business intelligence service 102 are possible.

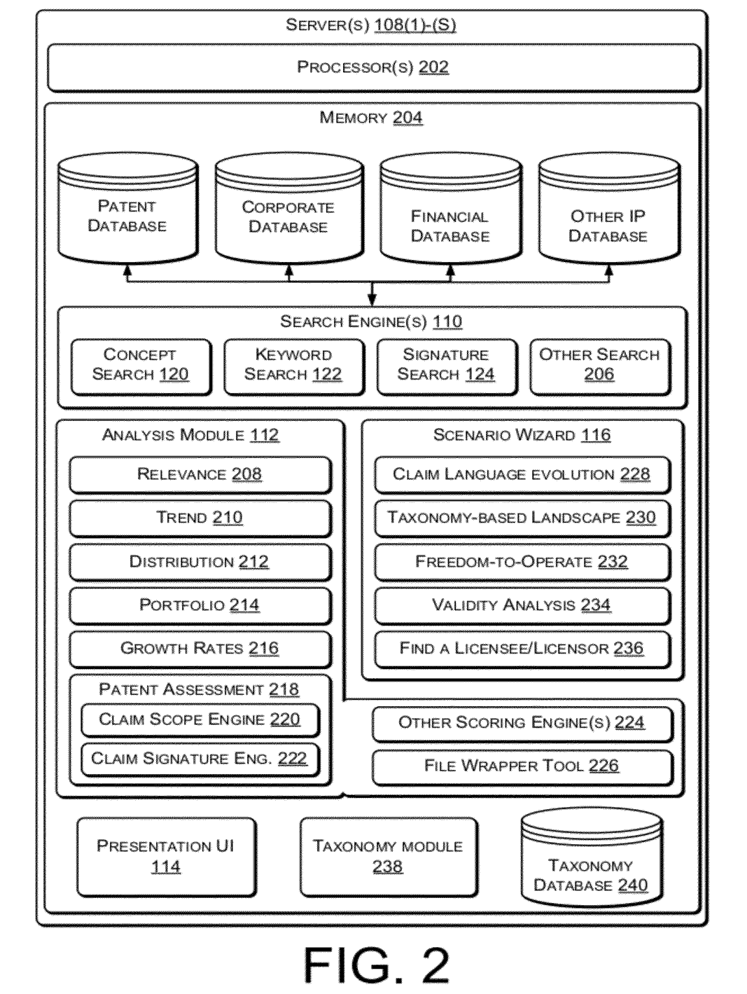

FIG. 2 shows one implementation of the servers 108 in more detail. Selected components in terms of modules are illustrated as being implemented by the servers 108. As shown in FIG. 2, a server 108 may include processing capabilities as represented by one or more processors 202 and storage capabilities as represented by memory 204. The memory 204 is representative of any number of forms of memory including both persistent and non-persistent memory. In one implementation, the memory 204 may include computer-readable media in the form of volatile memory, such as Random Access Memory (RAM) and/or non-volatile memory, such as read only memory (ROM) or flash RAM. The memory 204 is an example of computer-readable media. Computer-readable media includes volatile and non-volatile, removable and non-removable media implemented in any method or technology for storage of information such as computer readable instructions, data structures, program modules, or other data. Computer-readable media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. As defined herein, computer readable media does not include transitory media such as modulated data signals and carrier waves.

In one implementation, the memory 204 may include a plurality of databases 118. However, as noted above, in other examples the databases may be separate and apart from the memory 204. By way of example and not limitation, the memory 204 may include the patent database 126, the corporate database 128, the financial database 130, and the database for other IP 132 as shown in FIG. 1. In some implementations, the memory may further include one or more search engines 110 that are configured to discover various pieces of information from these databases 118. In one implementation, the search engines 110 may include the concept search engine 120. The concept search engine 120 identifies relevant documents based on a concept included in or derived from a search query. For example, a user 106 may provide a long textual description (such as a paragraph or page, or even a document, etc.) as an input query to the concept search engine 120. The concept search engine 120 may then determine or identify a concept from the input query, and search across one or more datasets in the databases 118 for concepts that are the same as or similar to the identified concept according to one or more predetermined metrics. As one particular implementation, the concept search engine 120 may be configured to employ a metric given by Latent Semantic Indexing (LSI) in which indexes of the data are pre-built to aid in the concept search.

The concept search engine 120 enables various types of sophisticated searches, including patentability searches, validity searches, and freedom-to-operate searches. For example, to perform a patentability search, the user 106 may input a description of a patentable idea, which may be a sentence, one or more paragraphs, or even a document. The concept search engine 120 deduces a concept from that input and searches the concept across a collection of documents, which might include patents, applications, technology literature, research white papers, foreign documents, and so forth. In one implementation, the concept search engine 120 may identify and return results which include information of the most relevant documents in a rank order of relevancy. The results may be presented graphically, or in a list form on a display of the computing device of the user 106. In the case of validity searching, the user 106 can enter all or part of a claim of a patent to be evaluated. The concept search engine 120 returns the most relevant documents, which can then be presented graphically, e.g., along a time line (or sorted by priority date), so that the user 106 can quickly identify references that may be relevant and predate the priority date of the patent being evaluated. In the case of freedom-to-operate searching, the user 106 can enter a description of a product or service being prepared for launch. The concept search engine 120 may then evaluate this description of the product (or determine and evaluate a concept included in this description) against patent claims in granted US patents and published applications. Specifically, the concept search engine 120 may maintain multiple latent semantically indexed collections, with the collections including entire patents and applications, or just portions thereof (e.g., just the claims, just the independent claims, just the abstract, etc.). In the freedom-to-operate case, the concept in the product/service description is searched relative to the claims and results are ordered according to relevancy with respect to the concept in the product/service description.

Additionally or alternatively, the search engines 110 may include the keyword search engine 122, in which a user 106 may enter one or more keywords to search across the databases 118. Depending on implementation details, the keyword search engine 122 may look for exact matches or approximate matches using fuzzy matching algorithms. The keyword search engine 122 may employ Boolean operatives such as “AND”, “OR”, and “NOT”, and/or implement proximity algorithms (e.g., finding a specific word that is separated from another word within a predetermined number of words, etc.) and weighting (e.g., giving varying weights to one or more words in a search query). One example implementation of the keyword search engine 122 employs SOLR technology of Apache Software Foundation.

Additionally or alternatively, the search engines 110 may include the claim signature search engine 124, which attempts to identify claims having similar signatures. As will be described below, one analysis tool provided by the IP-based business intelligence service 102 is to derive a unique signature for a claim (e.g., an independent claim, a dependent claim, etc.) in a patent or patent application. In one implementation, a claim signature of a claim may be a function of each unique word and/or phrase found in the claim, relative to respective occurrence frequency of each unique word and/or phrase in a collection of patents and/or applications. For instance, the collection of patents and/or applications may be gathered from a common and/or same technology area as the patent or patent application for which a claim signature of the claim is to be determined. This allows the words and/or phrases to share a common ontology, vocabulary and/or taxonomy. In one implementation, the collection may be obtained based on classification codes, such as the U.S. Patent and Trademark Office (USPTO) classes and subclasses, or the International Patent Codes (IPC).

In some implementations, prior to determining a claim signature of a claim, the claim signature search engine 124 may filter from the claim certain types of words and/or phrases that are useless in distinguishing the claim from other claims. By way of example and not limitation, the types of words and/or phrases to be filtered may include, for example, adjectives, adverbs, conjunctions, pronouns, articles, determiners, prepositions, etc. Additionally or alternatively, prior to determining a claim signature of a claim, the claim signature search engine 124 may retain only certain types of words and/or phrases including, for example, verbs, nouns, etc., that may describe acts and/or subjects (or objects) involved or included in a product or service protected by the claim. Additionally or alternatively, in some implementations, the claim signature search engine 124 may ignore words and/or phrases that indicate statutory classes (e.g., a process such as “method”, a machine such as a device, an article of manufacture such as computer readable media, a composition of matter such as a chemical compound, etc.) in determining a claim signature of a claim. Additionally or alternatively, when determining a claim signature of a claim, the claim signature search engine 124 may ignore a preamble of the claim. Additionally or alternatively, when determining a claim signature of a claim, the claim signature search engine 124 may ignore tenses of verbs in the claim.

Once a unique signature for a claim is found, the claim signature search engine 124 may further identify other claims having a substantially similar signature for the claim. In one implementation, the claim signature search engine 124 may find other claims using the same words/phrases or essentially similar words through the use of synonym or thesaurus libraries, stemming, truncating, or the like.

Additionally or alternatively, the search engines 110 may include other types of search engines 206 in addition or alternative to the above three example search engines. For example, the search engines 110 may include an image search engine. An inventor may be interested in knowing whether a design or pattern may be eligible for obtaining a design patent application or trademark protection. The inventor may provide a pictorial or graphical image of that design or pattern with or without a textual description as an input query, and the image search engine may recognize and/or match the image using conventional image recognition and/or matching algorithms to determine a pattern and/or concept in the image. Based on the determined pattern and/or concept, the image search engine may identify one or more design patents and/or patent applications (or registered trademarks) that include this determined pattern and/or concept that is the same as or similar to the pictorial or graphical image. Additionally or alternatively, the image search engine may further search the Internet to determine if anyone and/or any company has published a similar design or pattern on the Internet. The image search engine may return search results including the most relevant results (e.g., design patents, patent applications, trademarks, Internet-published images, etc.) to the inventor in an order of relevancy.

In one implementation, the search engines 110 may perform multiple types of searches concurrently (e.g., simultaneously, overlapping, etc.) or sequentially, with each type of search returning a results set. For example, the concept search engine 120, the keyword search engine 122, and/or the claim signature search engine 124 may be run relative to one or more inputs pertaining to a common search strategy. For instance, a user 106 might be interested in finding patents relevant to a particular patent or patent application. The user 106 may provide the particular patent or patent application (e.g., an electronic copy of the particular patent or patent application, an identified number such as application number or publication number of the particular patent or patent application, etc.) to the search engines 110. An excerpt from the particular patent or application may be provided to the concept search engine 120. Additionally or alternatively, one or more keywords from the particular patent or application may be provided to the keyword search engine 122. Additionally or alternatively, one or more claim signatures pertaining to one or more claims in the patent or application may also be input to the claim signature search engine 124. In one implementation, each search engine performs respective searches and generates result sets. The results sets are then compared with each other to determine whether one or more documents are found in two or more of the result sets. When a document is identified by multiple searches, a higher confidence may be applied to that document that it is relevant to the patent or application of interest. The combined results sets may be graphically presented akin to a Venn diagram, for example, where sets of circles or other shaped enclosures each encircling respective results sets, with the result sets overlapping at documents common to any combination of two or more result sets.

In some implementations, the search engines 110 may corporatively perform a search in a way that part or all of the search results from a search engine may be provided to one or more other search engines as an input and/or as a pool from which search results are retrieved. By way of example and not limitation, the user 106 may provide a claim of a patent or patent application for an invalidity search. Upon submitting a textual description of the claim to be invalidated to the search engines 110, the IP-based intelligence business service 102 may direct the claim signature search engine 124 to find one or more patents and/or patent applications that includes claims having claim signatures being similar to or the same as a claim signature of the claim to be invalidated. Upon finding one or more patents and/or patent applications that includes claims having claim signatures being similar to or the same as a claim signature of the claim to be invalidated, the keyword engine 122, for example, may extract one or more keywords from the top N (where N is a positive integer and selectable by the user 106 or predefined by the IP-based intelligence business service 102) patents and/or patent applications that include claims having claim signatures that are most similar to the claim signature of the claim to be invalidated. The keyword engine 122 may then use these extracted keywords to find one or more patents and/or patent applications that are relevant to these extracted keywords. Additionally or alternatively, the concept search engine 120 may extract excerpts (e.g., text corresponding to abstract, background, summary, overview, a portion of detailed description, etc.) from the top M (where M is a positive integer and selectable by the user 106 or predefined by the IP-based intelligence business service 102) patents and/or patent applications that include claims having claim signatures that are most similar to the claim signature of the claim to be invalidated. The concept search engine 120 may then determine concepts from the excerpts and perform an invalidity search using the determined concepts. In some implementations, search results obtained from one or more search engines 110 may be compared, and are ranked in a way that a higher ranking is given to a patent or patent application having been found by more than one search engine 110.

In one implementation, one or more of the search engines 110 (the concept search engine 120, the keyword search engine 122, and/or the claim signature search engine 124) may support a regular search for the user 106. For example, the search engines 110 may receive, from the user 106, any information associated with a patent document such as a filing date, an application number, a publication number, a classification, etc., and retrieve or return a list of patent documents or patent information that corresponds to the received information from the user 106. For example, the user 106 may input a classification (e.g., a patent classification adopted by the United State Patent and Trademark Office (USPTO)). In response to receiving the inputted classification, the search engines 110 may retrieve or return a list of patent documents classified under the inputted classification. As discussed in more detail below, the search engines 110 may present the list of patent documents graphically, for example, as cumulative line graph(s), trend(s) and/or rate(s) of change of number of granted patents and/or number of filed patent applications over a predetermined period of time.

Additionally or alternatively, the search engines 110 may receive a query related to a patentability search. For example, the search engines 110 may receive a textual description of a patent claim or a textual description that substantially describes the patent claim from the user 106. In one implementation, the search engines 110 may receive the textual description by receiving a document including the textual description of the patent claim or the textual description that substantially describes the patent claim. In some implementations, the search engines 110 may receive identification information of a patent document that includes the textual description of the patent claim. The identification information of the patent document may include an application number, a publication number, a patent number, and/or a combination of information associated with the patent document that may uniquely identify the patent document (such as a combination of a name of an inventor and a filing date, etc.). The search engines 110 may access the patent document and extract the textual description of the patent claim from the patent document. Alternatively, the search engines 110 may access a prosecution history or file wrapper associated with the patent document and extract the textual description of the patent claim from the prosecution history or file wrapper associated with the patent document. In one implementation, the search engines 110 may determine a document in the prosecution history or file wrapper that includes a latest version of the patent claim and extract the textual description of the patent claim from the determined document.

In response to receiving the textual description of the patent claim or the textual description that substantially describes the patent claim, the search engines 110 may obtain or retrieve a ranked list of results for the patent claim across a library of documents or from a database, for example. The database may include, but is not limited to, a patent database provided and/or supported by a patent office of a particular country (e.g., a USPTO (United States Patent and Trademark Office) database, a PAIR (Patent Application Information Retrieval) database, EPO (European Patent Office) database, WIPO (World Intellectual Property Organization) database, SIPO (State Intellectual Property Office of the P.R.C.) database, etc.), and any other databases that are provided by public and/or private institutions over the world. In one implementation, the ranked list may include patent documents ranked in a predetermined order (e.g., a decreasing order or an increasing order) of likelihood of rendering the patent claim unpatentable. Additionally or alternatively, the ranked list may include links of patent documents ranked in a predetermined order. In some implementations, the search engines 110 may further receive a date from the user 106. In an event that a date is received from the user 106, the search engines 110 may retrieve or return a ranked list of results including patent documents that have a filing date or a priority date prior to the date received from the user in a predetermined order as described above. Additionally or alternatively, the search engines 110 may perform a latent semantic-based concept search across a library of documents using the textual description of the patent claim as an input. Additionally, the search engines 110 may present the ranked list of results graphically. By way of example and not limitation, the search engines 110 may present the ranked list as a scatter plot having a first axis of time to represent dates of the retrieved patent documents and a second axis of relevancy to represent the likelihood of rendering the patent claim unpatentable.

In some implementations, the search engines 110 may receive a query related to an invalidity search. The search engines 110 may receive the query in a form of identification information of a patent document including a patent claim to be invalidated, a document including a patent claim to be invalidated and/or a textual description of a patent claim. In an event that the search engines 110 receives identification information of a patent document, search engines 110 may access the patent document and extract the patent claim to be invalidated from the patent document. In either case, the search engines 110 may formulate the query based on the patent claim, for example, using the claim language of the patent claim. The search engines 110 may perform a search using any of the above described search engines 110 such as the concept search engine 120, the keyword engine 122 and the claim signature search engine 124. The search engines 110 may search a library of documents or a database (e.g., USPTO database, etc.) using the formulated query.

In one implementation, the search engines 110 may obtain a ranked list of results based on the query. For example, the search engines 110 may obtain or retrieve one or more references that include one or more claim features or claim limitations of the patent claim. The one or more references may include, but are not limited to, one or more issued patents, published patent applications and/or non-patent literature such as journal articles, news, etc. Additionally, the search engines 110 may rank the one or more references based on respective one or more claim features or claim limitations included or found in the one or more references. By way of example and not limitation, the search engines 110 may rank the one or more references based on number of claim features or claim limitations of the patent claim that are included or found in the corresponding one or more references. In one implementation, a feature or claim limitation of a patent claim may include, but is not limited to, a group of words between any two delimiters, a group of words between two semicolons, a group of words between a semicolon and a full stop, etc. Additionally, search engines 110 may further propose one or more combinations of the one or more references that may combine to invalidate the patent claim (e.g., to render the patent claim obvious). For example, the search engines 110 may propose a combination of two or more references that, in combination, include all claim features or claim limitations of the patent claim. In response to obtaining or retrieving the ranked list of results, the search engines 110 may return the ranked list to a computing device of the user 106 for display. In some implementations, the results of the ranked list may include patent documents having associated dates. The search engines 110 may present the ranked list as, for example, a scatter plot having a first axis of time to represent the dates of the patent documents and a second axis of relevancy within the invalidity search.

In another implementation, the search engines 110 may receive a search query related to a freedom-to-operate search from the user 106. The user 106 may use any of the above search methodologies to prepare and submit the search query to the search engines 110. Additionally or alternatively, the search engines 110 may receive a date in the search query. Additionally or alternatively, the search query may include, but is not limited to, a country name or code, a classification of a taxonomy, a name of an assignee, a number of an inventor, a keyword, a textual description of a concept and/or any patent-related information of a patent document. In response to receiving the search query, the search engines 110 may retrieve or return a plurality of expired patents based on the received search query. Additionally or alternatively, the search engines 110 may retrieve or return one or more patent applications that are published and abandoned based on the received search query. In an event that a date is received in the search query, the search engines 110 may retrieve or return expired patents that have an expiration date prior to and/or on the received date. By finding patents that have been or will be expired after a particular date, for example, the search engines 110 allows the user 106 to determine whether and when he/she may make, sell and/or import products and/or services protected by these patents. In some implementations, the search engines 110 may receive an input query including a textual description of a product or service that is proposed or planned to be made, sold and/or imported. Additionally, the input query may include a country name or code for a country in which the product or service is proposed or planned to be made, sold and/or imported. Upon receiving the input query, one or more of the search engines (e.g., the claim signature search engine 124) may look for one or more patents and/or patent applications that include claims may read on the proposed product or service, and return search results of these patents and/or patent applications in an order of relevancy (such as the probability that the proposed product or service will infringed a patent or patent application, or the probability that a claim of the patent or patent application will read on the proposed product or service, for example).

In some implementations, the search engines 110 may allow the user 106 to submit a query for an infringement search (i.e., search for potential infringing products or services). By way of example and not limitation, the search engines 110 may receive a textual description of a patent claim of a patent or patent application from the user 106. The search engines 110 may receive the query in a form of identification information of a patent document including a patent claim for infringement search, a document including a patent claim for infringement search and/or a textual description of a patent claim for infringement search. In an event that the search engines 110 receives identification information of a patent document, the search engines 110 may access the patent document and extract the patent claim for infringement search from the patent document. In either case, the search engines 110 may formulate the query based on the patent claim, for example, using the claim language of the patent claim. In some implementations, the query may further include a technological or industrial field that a potentially infringing product or service is being looked for. Additionally or alternatively, the search engines may determine a technological classification for the patent claim based on a classification described in the patent or patent application of the claim, and limit the infringement search to the determined technological classification. The search engines 110 may perform a search using any of the above described search engines 110. The search engines 110 may search a library of documents, the databases 118, or a publicly available database (e.g., USPTO database, etc.) using the formulated query.

In one implementation, the search engines 110 may search for any patent or patent application that includes a claim that is relevant or similar to, and has a later effective filing date than, the received patent claim for which the infringement search is being conducted. Such an approach takes into account that companies with patents having similar claims but with later priority dates are likely to be producing products covered by the claims and are, therefore, likely candidates for infringement. By way of example and not limitation, a relevancy or similarity between two claims may be determined based on number of claim features or claim limitations that are common in the two claims. Additionally or alternatively, the search engines 110 may examine prosecution histories of granted patents and/or filed patent applications with later effective filing dates and determine which granted patents and/or filed patent applications include a prosecution history in which a patent or a patent application for which the infringement search is being conducted has been cited to reject claims of the granted patents and/or filed patent applications.

In some implementations, the search engines 110 may return a ranked list of results to the client device 108 for presentation to the user 106. The search engines 110 may rank the results based on relevancy or similarity to the patent claim for infringement search. Additionally or alternatively, the search engines 110 may rank the results based on types of rejections (§102 rejections, §103 rejections, etc.) used for rejecting claims of patents or patents applications found in the results. The ranked list of results may include owners of patent documents (i.e., granted patents and/or filed patent applications) and information (such as products that are launched within a predetermined period of time before and/or after filing dates or publication dates of the patent documents, etc.) associated with the owners of the patent documents. Additionally or alternatively, the search engines 110 may present the ranked list of results graphically, for example, as a scatter plot having a first axis of time to represent dates (such as filing dates or priority dates) of the patent documents and a second axis of relevancy or similarity within the infringement search. In some implementations, the search engines 110 may further allow the user 106 to input a date. In response to receiving the date from the user 106, the search engines 110 may retrieve patent documents having a filing date or a priority date after the received date, and return a ranked list of results to the computing device for presentation to the user 106.

Additionally or alternatively, in some implementations, the search engines 110 may search the Internet, online retailers, online shopping services, etc., for any product or service that may infringe the claim. Additionally or alternatively, the user 106 may indicate a specific industrial or technological field that he/she is interested in finding any potential infringement product or service. Additionally or alternatively, the search engines 110 may determine an industrial or technological field to look for any potential infringing products or services based on the technological classification given to or determined by the search engines 110. Additionally or alternatively, the search engines 110 may determine or expand a scope of industrial or technological fields to look for any potential infringing products or services by determining an industrial or technological sector to which a patent owner of the patent or patent application associated with the claim belongs. The search engines 110 may determine the industrial or technological sector to which that patent owner belongs to based on, for example, company information stored in the corporate database 128, the financial database 130, national or international database storing company directories such as New York Stock Exchange, NYSE Amex Equities, etc. Additionally or alternatively, the search engines may search websites of individual companies that are found to be within the same industrial or technological sector, field or classification as the claim, the patent or patent application that includes the claim, and/or the patent owner of the patent or patent application that includes the claim.

In some implementations, the memory 204 may further include an analysis module 112 that is executable by processors 202. The analysis module 112 may be configured to analyze the results returned by one or more of the search engines 110 or to analyze patents/applications that are identified by the user 106. The analysis module 112 may provide various analysis tools to return results in text, or as graphs, depending upon the intended knowledge to be conveyed. The analysis module 112 may perform many types of analyses. Several analyses are illustrated for discussion purposes. One type of analysis provided by the analysis module 112 may include a relevance analysis 208, in which results from one or more search engines 110 are returned and organized according to their relevance to the input query. A determination of how relevant documents are to a query may depend on a type of search being performed (concept search, keyword, both, etc.), a determination to be made based on the search (patentability, validity, freedom-to-operate, infringement, etc.), a taxonomy being employed (public, private, etc.), and the like. For example, the concept search engine 120 and the keyword search engine 122 may provide relevance values for the returned documents, and outputs may be provided in many forms, including in list form and/or on graphical presentations.

Additionally or alternatively, the analysis module 112 may include a trend analysis 210. The trend analysis 210 may be used to determine how patents (and/or patent applications) and other data evolve over time. Associations among the data from the various databases 118 may be applied in this temporal based trend analysis for identification of associations and patterns. For instance, the trend analysis 210 may discover macro filing trends of one or more intellectual property (or patent) owners or inventors, accumulation trends of patents or patent applications of the one or more intellectual property (or patent) owners or inventors in various categories or taxonomy levels, micro filing trends of the one or more intellectual property (or patent) owners or inventors among associated technologies, portfolio drift, and so forth.

In one implementation, the analysis module 112 may further include a distribution analysis 212. The distribution analysis 212 may be used to determine patterns in the aggregated data. For instance, patent data results may be pivoted among any number of factors to discover distribution information. Following a search, the user 106 may wish to know the top owners in the results sets, or the top inventors. Any number of pivots may be available, including owners, inventors, law firms, examiners, class, sub class, and so forth.

In some implementations, the analysis 112 may include a portfolio analysis tool 214 that may be used to support more sophisticated landscape studies of intellectual property landscapes and provide a unique breakdown of the various data. In one implementation, the portfolio analysis tool 214 employs a taxonomical approach to landscapes, defining various levels and sublevels of technologies and then mapping patent documents (e.g., grants, applications, pre-filed invention disclosure documents, etc.) against the taxonomy. The portfolio analysis tool 214 supports various public taxonomies, such as the USPTO classification system of classes and subclasses, as well as private or customized taxonomies.

Furthermore, a growth rate analysis tool 216 may further be included in the analysis module 112, and may be employed to evaluate not only how patent assets are accumulated over time, but also various growth rates such as filing rates and acceleration rates. The growth rate analysis tool 216 may be able to compute a filing rate based on the number of filings period over period (e.g., year over year, quarter over quarter, etc.) or by computing a first derivative of the accumulation curve. In one implementation, the growth rate analysis tool 216 may further be able to compute an acceleration rate based on an increase or decrease in filings for a period over period, or by computing a second derivative of the accumulation curve. The growth rate analysis may be applied to essentially any result sets.

The analysis module 112 may further include a patent assessment component 218, which analyzes patents and/or patent applications based on quality metrics. In one implementation, the patent assessment component 218 evaluates patent quality based upon the strength or breadth of the claims in the patent and/or patent application. In one implementation, the patent assessment component 218 may include a claim scope engine 220 and a claim signature engine 222. In one implementation, the claim scope engine 220 is configured to evaluate a patent and/or patent application based on the claim language and terms used in the claim. In some implementation, the claim scope engine 220 may evaluate a patent and/or patent application based on the claim language and terms used in the claim relative to all the other claims against which the claim is to be compared. In one particular implementation, a claim from a particular patent or application is compared to all the claims in all the patents and/or patent applications in a particular class or subclass of a classification or taxonomy system (such as USPTO classification, for example). Alternatively, the collection of patents and/or applications could be a result of a search, such as the claim signature search, the keyword search and/or the concept search. The claim scope engine 220 computes a scope of a particular patent claim as a function of a count of words and/or phrases used in the particular claim and a frequency count of the words and/or phrases from the particular patent claim as found in the plurality of patent claims. More particularly, the claim scope engine 220 first identifies each and every word and/or phrase used in claims in all patents and/or applications against which the claim is to be compared. The claim scope engine 220 may employ various language processing techniques to identify individual words, such as use of synonym libraries, removal of stop words, use of stemming, and so forth. In some implementations, the claim scope engine 220 may filter from the claim certain types of words and/or phrases that are useless in distinguishing the scope of the claim. By way of example and not limitation, the types of words and/or phrases to be filtered may include, for example, adjectives, adverbs, conjunctions, pronouns, articles, determiners, prepositions, etc. Additionally or alternatively, the claim scope engine 224 may retain only certain types of words and/or phrases including, for example, verbs, nouns, etc., that may describe acts and/or subjects (or objects) involved or included in a product or service protected by the claim. Additionally or alternatively, in some implementations, the claim scope engine 224 may ignore words and/or phrases that indicate statutory classes (e.g., a process such as “method”, a machine such as a device, an article of manufacture such as computer readable media, a composition of matter such as a chemical compound, etc.) in determining the scope of the claim. Additionally or alternatively, when determining the scope of the claim, the claim scope engine 224 may ignore a preamble of the claim. Additionally or alternatively, when determining the scope of the claim, the claim scope engine 224 may ignore tenses of verbs in the claim. Once each unique word is identified, that word is counted in each claim in the collection of patents/applications to discover its frequency of occurrence.

Each claim can then be assigned a first dimensional value (e.g., a y-value) based on the number or count of unique words in the claim and a second dimensional value (e.g., an x-value) based on the commonness of the words used in the claims as governed by the frequency counts throughout the entire collection. That is, words are said to be more common if they have relatively higher frequency values within the collection and less common if they have relatively lower frequency values within the collection. In one implementation, the y-value is a function of the count of unique words in a claim, such as the inverse of the unique word count (i.e., 1/UWcount), so that a larger y-value is assigned to claims with fewer unique words and a smaller y-value is assigned to claims with more unique words. In this manner, this first value or coordinate represents an underlying assumption or premise that claims with fewer unique words tend to be broader than claims with more unique words. Said more simply, shorter claims tend to be broader than longer claims. This is not always the case, particularly when considering claims in life sciences or chemical arts, but is considered to be a correct generalization.

The x-value may be a function of the collection-based frequency counts associated with each of the words in the claim. One particular implementation employs an algorithm of one divided by the sum of the inverse of each word's associated frequency count (i.e., 1/sum (1/Freq wd1+l/Freq wd2+ . . . +1/Freq wd n), where “Freq wd1” is the count of a number of occurrences of unique word 1 in the claims from the collection of patents/applications). Less common terms result in larger denominator values (i.e., 1/low_freq_value>1/high_freq_value), thus making the overall result smaller. A larger x-value is thus assigned to claims that use relatively more common words for the collection of patents/applications being evaluated and a smaller x-value is assigned to claims that use relatively less common words. In this manner, this second value or coordinate represents an underlying assumption or premise that claims with more common words tend to be broader than claims with less common words. Once again, this may not always be the case, but is considered to be a correct generalization.

With the x-value and y-value, each claim can then be plotted in a two-dimensional graph which visually reveals how a particular claim compares in terms of word count and commonness to all of the other claims in the collection of patents being reviewed. Thus, for a given patent having M claims, the plot may show M designators or marks in a two-dimensional area. The location of the designators or marks indicates whether the claims are relatively broader or narrower within the collection. Claims with x- and y-values closer to the origin (i.e., claim has many words and the words contain uncommon words) are said to be narrower than claims farther from the origin (i.e., claims with fewer words and the words are more common).

By using two vectors, the claim scope engine 220 also moderates each of the underlying assumptions or premises. For example, if a claim is relatively shorter, but uses very uncommon terms, a patent practitioner might still consider the claim to be narrow due to the restrictive language in the claim. Accordingly, the first vector or word count (i.e., y-value) may receive a relatively higher value, but the second vector or commonness value (i.e., x-value) would receive a relatively lower value. This would move the point back closer to the origin than had the claim been short and used very common words for that technology sector or collection.

With the x- and y-values, the claim scope engine 220 may also compute a distance value from the origin. In this manner, each claim in a patent or patent application may have a unique distance value based on these two values or coordinates. The distance value may then be used to rank or otherwise order any results from the search engines 110 and analysis tools or modules 112. Further, the distance value may be used to alter visual appearances in various graphical outputs, to convey to the user which assets in a given view may be broader than others. For instance, in a portfolio view or concept scatter plot, the distance value may be employed to alter sizes, the color intensities or color frequencies of designators or marks in results shown in the portfolio view or concept scatter plot to visually convey relative quality or breadth of corresponding claims in patents and/or patent applications.

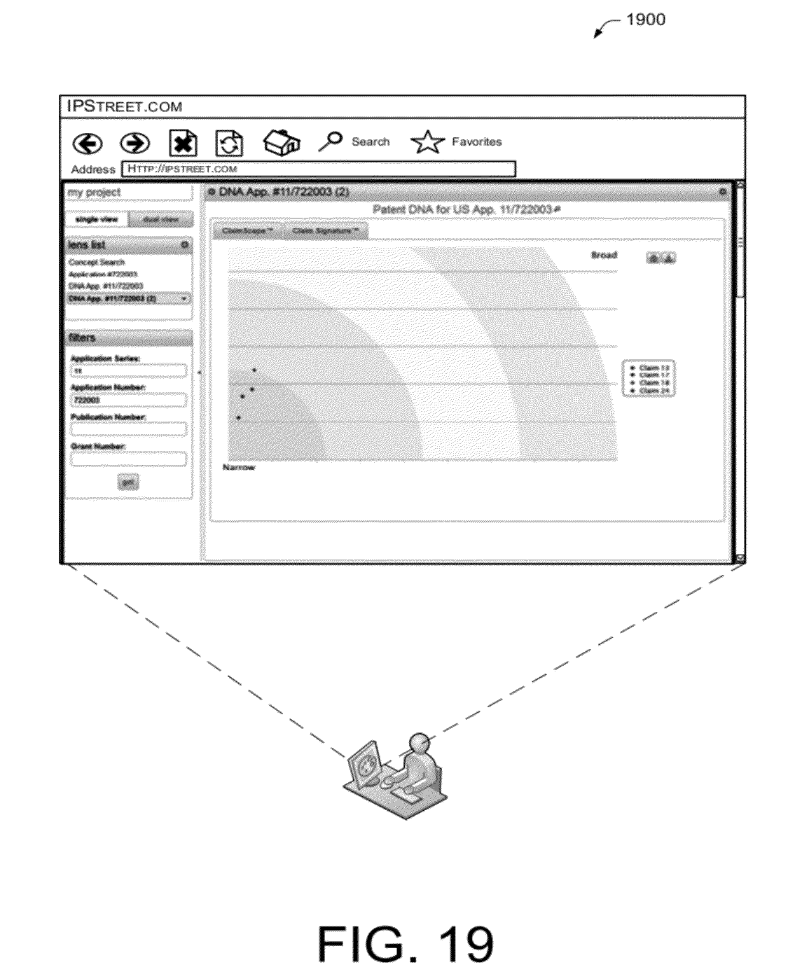

The claim signature engine 222 is configured to evaluate a patent and/or patent application by identifying a unique signature of one or more claims (e.g., one or more independent claims, dependent claims, etc.) contained in the patent or application. More particularly, the claim signature engine 222 computes a signature of a particular claim as a function of the words and/or phrases used in the particular claim and a frequency count of the words and/or phrases in a large collection of claims from multiple patents and/or patent applications. The unique signature for a claim can also be presented in a graphical user interface that identifies the words in a claim and how common those words are to a collection of claims in a similar technology space. Examples of the graphical outputs of the claim scope engine 220 and the claim signature engine 222 are described in more detail below with reference to FIG. 19 through 25.

The analysis module 112 may further include other types of scoring algorithms 224 that are used to assess patents or patent applications. Whereas the claim scope engine 220 and the claim signature engine 222 represent scoring engines that assess the actual claim language, other scoring engines may attempt to assess quality, value, innovativeness, or other characteristics of a patent or patent application based on other factors. Examples of other types of scoring algorithms might include forward citation algorithms, backward citation algorithms, a combination of forward and backward citation algorithms, maintenance fee payment algorithms, and file wrapper history algorithms. Each of these scoring algorithms attempts to assess a quality of a patent and/or patent application based on these various factors or characteristics of the patent or patent application.

For example, a forward citation algorithm may assess quality of a patent or patent application of interest by determining a number of times the patent or application is cited or referenced by other patents and/or patent applications, and assign a higher score to the patent or application if the number of times that patent or application is cited or referenced by other patents and/or patent applications is larger.

A backward citation algorithm may assess quality of a patent or application by determining number (and/or recentness) of references that the patent or application cited or referenced during its prosecution. The backward citation algorithm may give a higher or same weight to non-patent literature than patents (and/or patent applications) and/or assign a higher score to the patent or patent application if the number (and/or recentness) of references that the patent or patent application cited during its prosecution is lower.

A maintenance fee algorithm may assess quality of a patent or application by determining whether one or more maintenance or annuity fees have been paid in time or failed to be paid for the patent or application, and assign a higher score to the patent or application the longer it is maintained. The rational for this algorithm is that companies will not maintain patents or applications that are of low quality, low value, and/or are out dated, as long as they maintain patents or applications that are of high quality, high value, and/or are of continued commercial significance.

A file wrapper history algorithm may assess quality of a patent or application by determining its prosecution history before a patent office, giving a higher score to the patent or application if the prosecution history is shorter in time, involved fewer claim amendments and/or office actions, involved less extensive claim amendments, etc. In some implementations, the analysis module 112 may further normalize the scores returned by the above scoring algorithms for the patent or application based on respective predetermined thresholds or respective average numbers for patents or applications in the same technological field or classification (e.g., USPTO classification), before the same patent examiner, or the like.

By implementing multiple and various engines, the analysis module 112 is capable of evaluating patents and/or patent applications through a combination of multiple scoring algorithms. For instance, a user may assess a single patent using one or more of the claim scope engine 220, the claim signature engine 222, and one or more of the other scoring engines, such as forward and backward citation algorithms, maintenance fee algorithms, and so forth. In one implementation, the multiple scoring algorithms for evaluating a patent or patent application may be presented via a user interface that enables the user to select one or more combinations of scoring algorithms with which to rank or sort a collection of patents or applications. For example, the analysis module 112 may select a number of scoring algorithms from the scoring engines (e.g., the claim scope engine 220 and the claim signature engine 222) and/or other scoring algorithms, and use these selected scoring algorithms to assess the quality of a patent or application. In one implementation, the analysis module 112 may generate a composite score, e.g., a combination of weighted scores returned from these selected scoring algorithms. In some implementations, the analysis module 112 may individually return these scores from the scoring algorithms to enable representing various quality metrics (such as claim scope, etc.) for the patent or application.

The analysis module 112 may further implement a file wrapper tool 226 that determines a change in claim scope that resulted from prosecution of a patent application to issuance. In one implementation, the file wrapper tool 226 examines independent claims in a published application and identifies the broadest claim. The file wrapper tool 226 may retrieve distance values calculated by the claim scope engine 220 for each claim in the patent application, and select the claim with the largest distance value, which is representative of the broadest claim. The file wrapper tool 226 next examines independent claims in the corresponding issued patent and identifies its broadest claim. Once again, the file wrapper tool 226 may retrieve distance values calculated by the claim scope engine 220 for each claim in the granted patent, and select the claim with the largest distance value.

The file wrapper tool 226 then computes a change value representing a change in scope from the broadest claim in a patent application relative to the broadest claim in the granted patent. In one implementation, the file wrapper tool 226 computes a percentage change from a first distance for an application claim to a second distance of a granted claim. This percentage serves as a proxy for the change in scope of the patent as a result of amendments made during prosecution. This change-in-scope approximation is very useful to a practitioner as it provides insights as to how much activity occurred during prosecution without having to review the file wrapper history. Additionally or alternatively, the file wrapper tool 226 may compute a change value representing a change in scope for a particular claim (e.g., an independent claim) in a patent application from a particular stage (e.g., at the time of filing the patent application, at the time of filing a response to an Office Action, etc.) to the time when the particular claim (possibly with claim amendments) is allowed. The file wrapper tool 226 may identify or follow that particular claim throughout the prosecution of the patent application based on its claim number, similarity or correlation between claims in responses for two consecutive Office Action, etc. The file wrapper tool 226 may compute a change value for each change in scope for that particular claim between two Office Actions or between responses filed for two Office Actions, etc. The file wrapper tools 226 may graphically or textually (e.g., in tabular or list form, etc.) present each change value to the user 106. This allows the user 106 to quickly and easily identify a particular stage or point in time that an activity that may substantially affect the scope of the claim. Moreover, this may also allow the user 106 to focus on activities occurred at that particular stage or point in time to determine whether claims of one or more patents and/or patent applications cited for rejecting the claim at that particular stage or point in time are related to a product or service covered by the claim at issue and whether a subset of the one or more patents and/or patent applications are worth to be acquired or a license thereof is worth to be obtained.

Furthermore, results from two or more analysis tools included in the analysis module 112 may be combined to provide even greater insights for the user. For instance, a user may use the portfolio tool 214 to illustrate patent assets of a particular owner or inventor. In these views, the graphical elements used to represent the assets may be modified (e.g., size, color, intensity, etc.) based on the claim scope score. That is, assets deemed relatively broader (i.e., higher distance value) will be enlarged or changed in color or otherwise modified relative to other assets. As another example, results from search engines may be sorted or graphically represented according to claim scope.

One or more scenario wizards 116 may also be stored in memory 204 and executed by the processors 202. Several example scenario wizards are shown for discussion purposes. Each scenario wizard guides a user through a set of questions or requests that form inputs to the various analysis tools. In this manner, the user 106 need not be an IP specialist or even familiar with IP. Instead, the wizards 116 extract appropriate information, initiate proper tools, and present results that are intuitive and actionable to the user.

One scenario wizard 116 is a claim language evolution wizard 228 in which a user 106 is guided through a set of analytical tools to view how particular claim language in a patent document has evolved over time. A certain phrase or keyword may be input and tracked through various patent documents over a period of time to help the user ascertain how that claim language has evolved in a taxonomy. As an example, the user may be asked to input a word or phrase, and all claims containing that word or phrase are presented along a time line.

Another scenario wizard 116 that may be employed is a taxonomy-based landscape wizard 230 in which patent landscapes are plotted according to a technology-relevant taxonomy that classifies patent documents according to particular technology classifications. The taxonomy-based landscape wizard 230 asks the user 106 for entry of some information that helps identify a set of patent assets, such as a company name, inventor, technology area, search query, and so forth. The taxonomy-based landscape wizard 230 may further ask for time constraints or date ranges and whether the user 106 would like to apply a patent assessment score, such as claim scope to the results. The landscape-based wizard 230 may also inquire as to whether the user would like to consider comparing the results to another company, inventor, and so forth.

The taxonomy-based landscape wizard 230 takes the simple input, such as an owner name, and maps relevant patent documents to the technology taxonomy. The patent documents can further be arranged according to priority date so that the user 106 can see how the assets align relative to both the technology classification as well as the timeframe within which the asset was procured. Additionally, graphical elements representing assets may be scaled, colored, or otherwise visually varied to represent assessment scores applied to the patent assets. The taxonomy-based landscape wizard 230 allows the user to view landscapes at high level and iteratively drill into lower and lower levels to see how those assets are grouped. From such taxonomy-based landscapes, users can identify risk areas and opportunities as well as white space in which very little patent activity has taken place to date.

A freedom to operate wizard 232 facilitates another scenario that may be offered by the service 102. The wizard 232 prompts the user to enter a description of a technology that is about to be released, and an identification of which geographical markets it is to be released. This description is entered as a query in the concept search engine 120, and the limiting parameter of “claims only” is automatically selected and the corresponding patent territories are selected. In this manner, the description is searched against all claims in the patent database pertaining to the selected patent territories. The returned results provide a listing of relevant patent claims that may then be evaluated against the description of the product to inform the user of any potential risk of infringement were the user to launch a product of that description.

A validity analysis wizard 234 is yet another scenario that may be offered which allows a user 106 to evaluate the validity of a patent claim. The user 106 is prompted to enter a patent or application number and if known, to identify one or more claims in the patent to be evaluated for validity. In response, the validity analysis wizard 234 accesses the patent records for the entered patent number, extracts the identified claim and any priority data, and enters the claim as a query to the concept search engine 120. The claim is then searched against all of the patent documents in the patent database (regardless of territory or country) and/or the database for non-IP data including printed publications such as non-patent literature, journals, brochures, etc. Documents that pre-date the priority data associated with the patent claim may then be analyzed to determine whether or not the claim, as issued or published, is likely valid or not.

Another scenario that may be offered by the IP-based business intelligence service 102 is a find a licensee/licensor scenario 236. In this particular scenario, a user 106 may be prompted to enter a description of relevant technology, or identify a patent number. This input is then fed into the concept and/or keyword search engines, and the results are analyzed to identify current companies that have the most relevant assets. After the user 106 has identified a collection of potential companies with similar interests, additional analysis can be used with the growth rate analysis modules to identify which of this collection of companies may be actively patenting in this particular area as evidenced by acceleration trends in that particular technology area. This list may then be ranked and organized and presented back to the user to help the user identify a potential licensee or licensor.

The presentation user interface (UI) 114 is also shown stored in memory 204 for execution on the processors 202. The presentation UI 114 lays out the various results from the search, as analyzed by their various analysis modules, for presentation back to the users. The presentation UI 114 may rely on any number of visual graphics. The specific visual graphics employed in any given analysis or scenario wizard are configured to convey intuitively the results of the search and analysis.

In one implementation, the memory 204 may further include a taxonomy module 238. The taxonomy module 238 enables a user 106 to select a taxonomy from a plurality of taxonomies that are stored in a taxonomy database 240. In one implementation, the plurality of taxonomies may include, for example, publicly available taxonomies and private taxonomies. Publicly available taxonomies may include, but are not limited to, taxonomies provided and/or supported by government agencies such as patent offices of various countries (such as USPTO, SIPO, etc.) and/or organization (such as PCT, EPO, etc.), taxonomies defined by standards setting organizations, etc. Private taxonomies may include, for example, a taxonomy defined by a private company. Additionally or alternatively, in some implementations, the plurality of taxonomies may include one or more customized taxonomies including, for example, a taxonomy customized for a particular technology, a taxonomy customized for a particular company, a taxonomy customized for a particular industry, etc.

In one implementation, the taxonomy module 238 may provide the plurality of taxonomies to the user 106 for selecting a taxonomy therefrom. By way of example and not limitation, the user 106 may perform a patent search using service 102. The user 106 may select a particular taxonomy from one or more taxonomies available to him/her, and provide a search query to one or more of the search engines 110 (e.g., the concept search engine 120, the keyword search engine 122, and/or the claim signature search engine 124). The search engines 110 may then perform a search for patents and/or applications based on the search query and the selected taxonomy. In some implementations, the search engines 110 may return search results to the user 106 in a graphical form, a tabular form and/or a list form. In one implementation, the search results may be arranged based on relevancy of the returned patents and/or applications to the search query. Additionally or alternatively, the search results may be arranged based on classifications or categories of the selected taxonomy to which respective patents and/or applications belong. In one implementation, the search results may include number of hits (i.e., number(s) of patents and/or applications) for each classification or sub-classification. The user 106 may select a particular classification which may be expanded to show information of the patents and/or applications under that particular classification.

In some implementations, the user 106 may want to find one or more patents and/or applications within a particular classification or category such as electronic commerce. The user 106 may select a particular taxonomy from one or more taxonomies available to him/her. The user 106 may further input one or more particular classifications or categories (e.g., “electronic commerce”, etc.) under the selected taxonomy he/she wants to find related patents and/or applications. Alternatively, the user 106 may input one or more specific classification codes (e.g., a specific classification code for “electronic commerce” in this example) to the service 102. The service 102 or the search engines 110 provided by the service 102 may perform a search for the user 106 based on a search query provided by the user 106 and the one or more particular classifications of the taxonomy selected by the user 106. The search engines 110 may return search results that may be displayed to the user 106 as described above.

In one implementation, the service 102 or the search engines 110 may enable the user 106 to change or switch the taxonomy to another taxonomy from the taxonomies available to the user 106. In response to receiving a selection of a new taxonomy, the service 102 or the search engines may retrieve new search results based on the search query and the newly selected taxonomy, and return the new search results to the computing device of the user 106 for display to the user 106. Additionally or alternatively, the service 102 or the search engines 110 may enable the user 106 to change the order and/or the way of displaying the search results to him/her. By way of example and not limitation, the service 102 or the search engines may provide display options to the user 106 through the presentation UI 114.

In some implementations, the taxonomy module 238 may enable the user 106 to submit a new taxonomy to the taxonomy database 240. In one implementation, the taxonomy module 238 may allocate a memory space for the user 106 to store any taxonomy submitted by the user 106. In some implementations, the taxonomy module 238 may first authenticate or validate the user 106 (e.g., by examining a password and/or username submitted from the user 106) prior to allowing the user 106 to submit a new taxonomy. In one implementation, the new taxonomy submitted by the user 106 may be viewable and/or usable by the user 106 only. In an alternative implementation, the new taxonomy submitted by the user 106 may be viewable and/or usable by other user 106 and/or the service 102 with or without knowledge or permission of the user 106 who submitted the new taxonomy. For example, after the user 106 has submitted the new taxonomy to the taxonomy database 240, the search engines 110 will enable the computing device of the user 106 to display this new taxonomy together with any previous taxonomies provided by the search engines 110 for performing a search.

In one implementation, one or more of the search engines 110 (and/or the portfolio analysis tool 214 or the taxonomy-based landscape wizard 230) may further be configured to perform a patent search for a given taxonomy or list of keywords or concepts. By way of example and not limitation, a user 106 may provide a taxonomy including a hierarchy (e.g., a hierarchical tree or forest, etc.) of classifications as an input query. Each classification may be represented by a keyword or a concept. In some implementations, the provided taxonomy may further include respective index for each classification. The user 106 may provide this taxonomy by various input methods including, for example, typing, copying and pasting, uploading a file including the taxonomy, etc. In some implementations, the search engines 110 may further allow the user 106 to provide a name (e.g., an inventor, owner or assignee, etc.) and allow the user 106 determine a patent portfolio of the inventor, owner or assignee under the provided taxonomy or other taxonomy provided by the search engines 110. In one implementation, the search engines 110 may allow the user 106 to provide multiple names (e.g., one or more inventors, owners and/or assignees, etc.) and allow the user 106 to compare patent portfolios between inventors, owners and/or assignees under the provided taxonomy or other taxonomy provided by the search engines 110.

In one implementation, upon receiving the taxonomy, one or more of the search engines 110 (e.g., the keyword search engine 122, etc.) may perform a patent search for each classification of the taxonomy to obtain a plurality of related patent documents for each classification. The search engines 110 may then compare patent documents obtained for two classifications which are of parent-and-child relationship. For example, the search engines 110 may compare patent documents obtained for a first classification with patent documents obtained for a second classification, where the first classification is an intermediate child of the second classification. The search engines 110 may filter any patent document that is not included in the patent documents for the second classification from the patent documents associated with the first classification. Furthermore, the search engines 110 may compare patent documents associated with a classification with all patent documents obtained for classifications that are its immediate children of that classification, and retain only patent documents for that classification if these patent documents are found in the patent documents obtained for its immediate child classifications. When a patent document is filtered from patent documents associated with a particular classification, the search engines 110 may propagate this information upward and/or downward in order to perform corresponding filtering for patent documents associated with its parents and children. Upon completing searching and filtering for each classification of the taxonomy, the search engines may return search results to the computing device of the user 106 for presentation. The search results may include, for example, number and information of patents and/or applications found for each classification of the taxonomy, etc.

Additionally or alternatively, in some implementations, the search engines 110 may perform this type of taxonomy search in a top-down manner. By way of example and not limitation, the search engines 110 may identify a classification at the top (e.g., the first level) of the hierarchy (e.g., a hierarchical tree), and perform a keyword or concept search for a keyword or concept associated with that classification at the first level of the hierarchical tree. Upon obtaining or retrieving a plurality of related patent documents for that top classification, the search engines 110 may perform a new keyword or concept search for a keyword or concept provided in each classification that is an immediate child of the top classification, i.e., classifications at the second level of the hierarchical tree. In response to obtaining a plurality of related patent documents for each child classification, the search engines 110 may aggregate all the related patent documents obtained for the second-level classifications having the same immediate parent classification (i.e., the top classification in this case). The search engines 110 may then compare the aggregated patent documents obtained for the child classifications with the patent documents obtained for their immediate parent classification, and retain patent documents that are common thereto. Specifically, a patent document is filtered or removed from the patent documents associated with the parent classification (i.e., the top classification in this case) if that patent document is not found in the aggregated patent documents for all the child classifications of the parent classification. Furthermore, a patent document is filtered or removed from the patent documents associated with an immediate child classification if that patent document is not found in the patent documents for the parent classification. The search engines 110 may repeat searching, aggregating, comparing and filtering for subsequent levels of the hierarchy of the taxonomy until the lowest level is reached, for example. Moreover, when a patent document is filtered from patent documents associated with a particular classification, the search engines 110 may propagate this information upward in order to perform corresponding filtering for patent documents associated with its parents. Upon completing searching and filtering for each classification of the taxonomy, the search engines may return search results to the computing device of the user 106 for presentation. The search results may include, for example, number and information of patents and/or applications found for each classification of the taxonomy, etc.

Additionally or alternatively, in some implementations, the search engines 110 may perform this type of taxonomy search in a bottom-up manner. For example, the search engines 110 may identify one or more classifications at the lowest level of the hierarchy, and perform a keyword or concept search for a keyword or concept associated with each of the one or more classifications at the lowest level. Upon obtaining or retrieving a plurality of related patent documents for each of these one or more classifications at the lowest level, the search engines 110 may perform a new keyword or concept search for a keyword or concept provided in each classification at the next higher level. In response to obtaining a plurality of related patent documents for each classification at the next higher level, the search engines 110 may aggregate all the related patent documents obtained for the lowest-level classifications having a same immediate parent classification. The search engines 110 may then compare the aggregated patent documents obtained for the child classifications with the patent documents obtained for their immediate parent classification, and retain patent documents that are common thereto. Specifically, a patent document is filtered or removed from the patent documents associated with the parent classification if that patent document is not found in the aggregated patent documents for all the child classifications of the parent classification. Furthermore, a patent document is filtered or removed from the patent documents associated with an immediate child classification if that patent document is not found in the patent documents for the parent classification. The search engines 110 may repeat searching, aggregating, comparing and filtering for subsequent levels of the hierarchy of the taxonomy until the highest level is reached, for example. Moreover, when a patent document is filtered from patent documents associated with a particular classification, the search engines 110 may propagate this information downward in order to perform corresponding filtering for patent documents associated with its children. Upon completing searching and filtering for each classification of the taxonomy, the search engines may return search results to the computing device of the user 106 for presentation. The search results may include, for example, number and information of patents and/or applications found for each classification of the taxonomy, etc.

### Illustrative User Interfaces

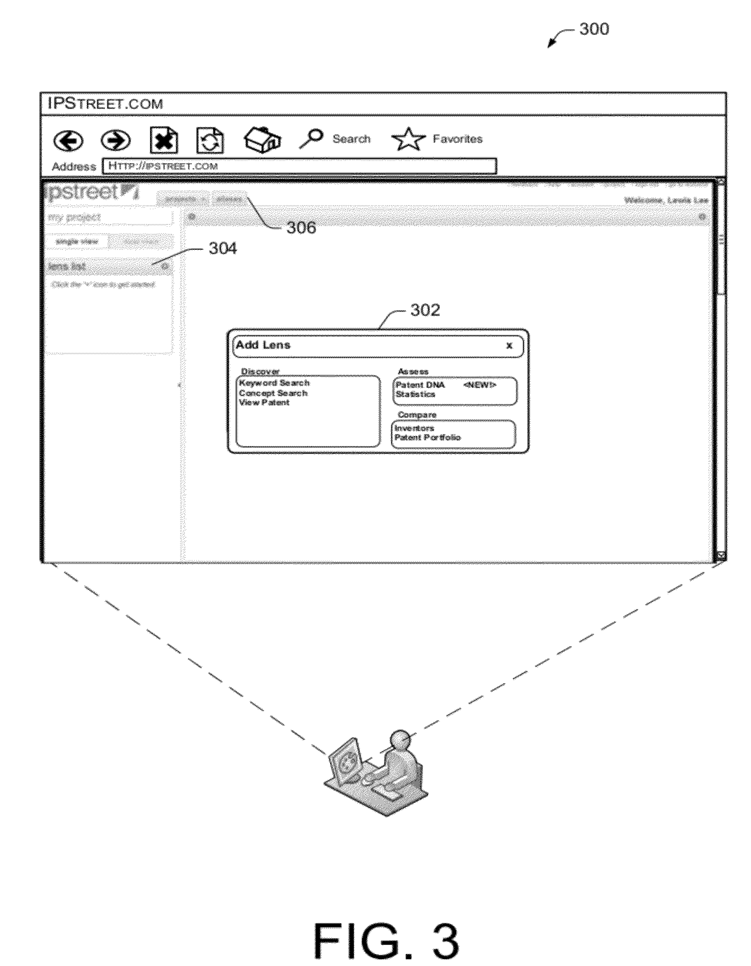

FIG. 3 shows a user interface (UI) 300 rendered on a browser of a user device. UI 300 represents a main page that is presented after the user securely logs on to the IP-based business intelligence service 102. In one example implementation, the cloud application is designed around a project metaphor in which users can define multiple projects and within each project may analyze data through any number of lenses. At the center of the main page 300 is an “add lens” menu 302 with a list of lenses. The lenses are grouped according to their functional purposes. In FIG. 3, three categories of lenses are illustrated: discover, assess, and compare. In other implementations, there may be more or less than these categories. For instance, in other implementations, four categories of lenses may be used: discover, measure, compare, and connect.

The “discover” category of lenses is designed to allow users to search and explore the various databases (e.g., the databases 118). In essence, the user is permitted to look around the aggregated data to discover items of interest. Within this category, three lenses are illustrated: keyword search, concept search, and view patent. As will be described below in more detail, the keyword search lens allows users to search the databases based on keyword queries. The concept search lens allows users to search the databases according to concepts defined in the query. Individual concepts may include sentences, paragraphs, or documents. Typically the query entered into a concept search contains far more words than are found in a common keyword search. The view patent lens allows the user to pull up individual patents or patent applications and view them. The data contained in the patents are laid out according to various data fields and the user is also given the option to view the patent or application as published by a patent office, e.g., the United States Patent and Trademark Office.

The “assess” category of lenses is designed to allow users to measure individual assets or a portfolio of assets. In this example, a patent DNA lens provides a way to examine the quality of a patent or patent application by assessing the claim language. The patent DNA includes a claim signature that uniquely identifies individual claims in a database of patents/applications, and a claim landscape that evaluates claim scope of individual claims relative to other claims. Another lens in the “assess” category is a statistics lens, which provides projected metrics that measure the breadth and quality of a patent portfolio or individual patent.

The “compare” category of lenses is designed to permit a user to compare various assets or portfolios to one another. The compare category allows, for example, executives to benchmark their own portfolios against those of others. In the “compare” category, an inventor lens is shown to help users identify key inventors in particular companies or technology areas. A patent portfolio lens is also found in the “compare” category to examine patent portfolios of individual companies to ascertain a patent landscape of those companies, or of technology areas to evaluate top companies in the space.

The main page 300 also has a project management area 304 arranged along one side (e.g., the left hand side) of the user interface. Within this project management area, users can select lenses and those lenses will be tracked. The user may rename lenses, add, or delete lenses as desired. The user may also add, delete, or rename projects. Also shown as part of the user interface, the main page 300 and subsequent pages throughout allow the user to see lenses presented in a single view with just a single lens being depicted, or in a dual view in which two lenses may be presented side by side.

The main page 300 may also have an alias tab 306 that enables users to define super groups for purposes of searches. For instance, the user may define an alias for a company that includes all the various entities owned or partially owned by the company. These entities are aggregated and results depicted as if it were a single company.

For discussion purposes, suppose the user selects the keyword search lens in the “discover” category. The user can select (e.g., touch, mouse to, etc.) that item, select (e.g., touch, click, etc.) and open an instance of that lens.

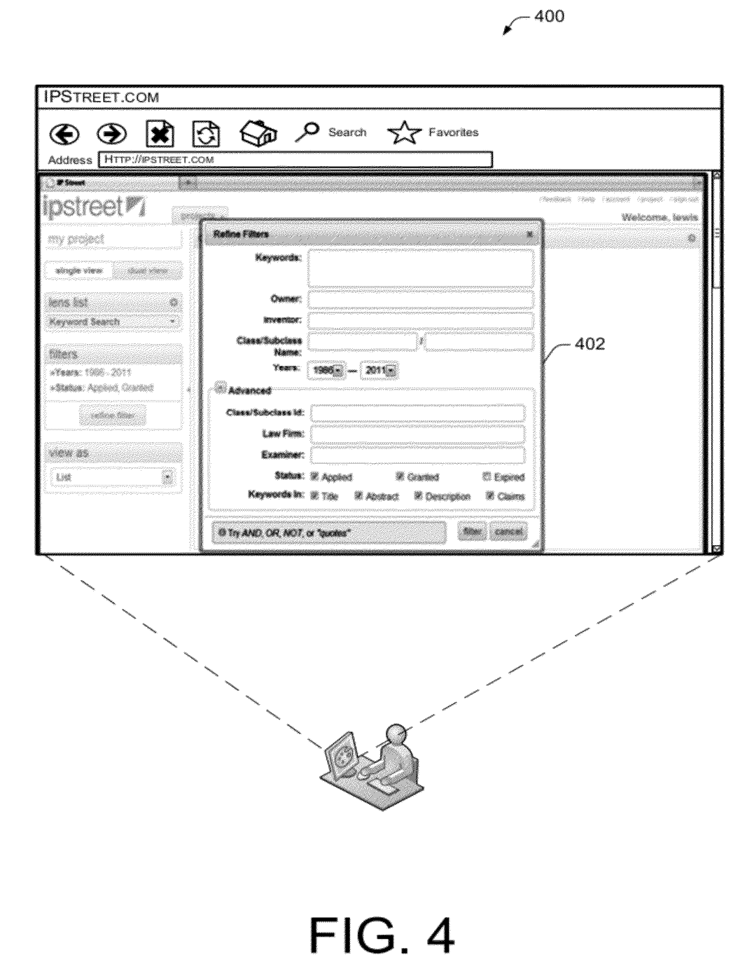

FIG. 4 shows a screen rendering 400 that is provided in response to a user selecting the keyword search from the menu on the home page 300 in FIG. 3. In this UI, the keyword search is added to the lens list in area 304 and a set of filters is provided to allow user entry of a particular search. A “refine filter” input box 402 is presented at the center of the UI 400. The user may enter any number of items to initiate a search. In this particular example, the input box 402 includes a keyword entry field to enable users to enter one or more keywords to be searched across the various patent documents. An owner entry field allows the user to enter one or more owners or assignees of the patent documents. An inventor entry field is provided to allow entry of one or more inventors who are named on various patents. A class/subclass name entry field is provided to allow users to enter search terms associated with particular technology areas. A user is not expected to know the particular classification identifiers (IDs) and hence this entry field allows users to enter the technologies by keyword. For example, rather than knowing that software is classified in Class 705 at the U.S. Patent and Trademark Office, for example, the user may simply enter the term “software” or a particular version of software such as “word processing”, into the class/subclass name field. The search engine will then match the entered item against all possible classes and subclasses at the U.S. Patent and Trademark Office. The “years” input field allows the user to specify a year range for which results are desired.

Many additional fields may also be employed as represented by the advanced portion of the refine filters menu that can be selected to expand the search options. Within this area is a class/subclass ID entry field that allows users to enter the exact class and/or subclass numbers. A law firm entry field allows the user to input one or more law firms of interest. An examiner entry field allows users to enter the names of one or more examiners. A status entry field provides a list of the type of assets that the user may be interested in, including pending applications, granted patents, and expired patents. The last entry field shown in this example is an entry field that allows the user to select what part of the patent document is to be used for the searching of the keywords. For instance, the engine allows the user to determine whether to search for keywords in the title, abstract, detailed description, and/or claims sections of the patent documents. Boolean operations such as “AND”, “OR”, “NOT”, and “EXACT MATCH” may be applied or used in any one of the entry fields.

For discussion purposes, suppose the user decides to enter keywords into the keyword entry slot at the top of the refine filter popup menu. As one example, suppose the user enters the phrase “online shopping cart” in an effort to identify an exact match where the phrase “online shopping cart” is used in various patent documents. When the user is satisfied with the search query, the user may actuate the filter button to initiate the search.

At this point, the keyword search engine 122 searches all of the documents in the database (e.g., patents, patent applications, other printed or electronic publications such as non-patent literature, etc.) for any documents that contain a match of the input query. The keyword search engine 122 identifies a set of documents that satisfy the search query. The results may be presented in any number of ways, including list views, graphical views, and so forth.

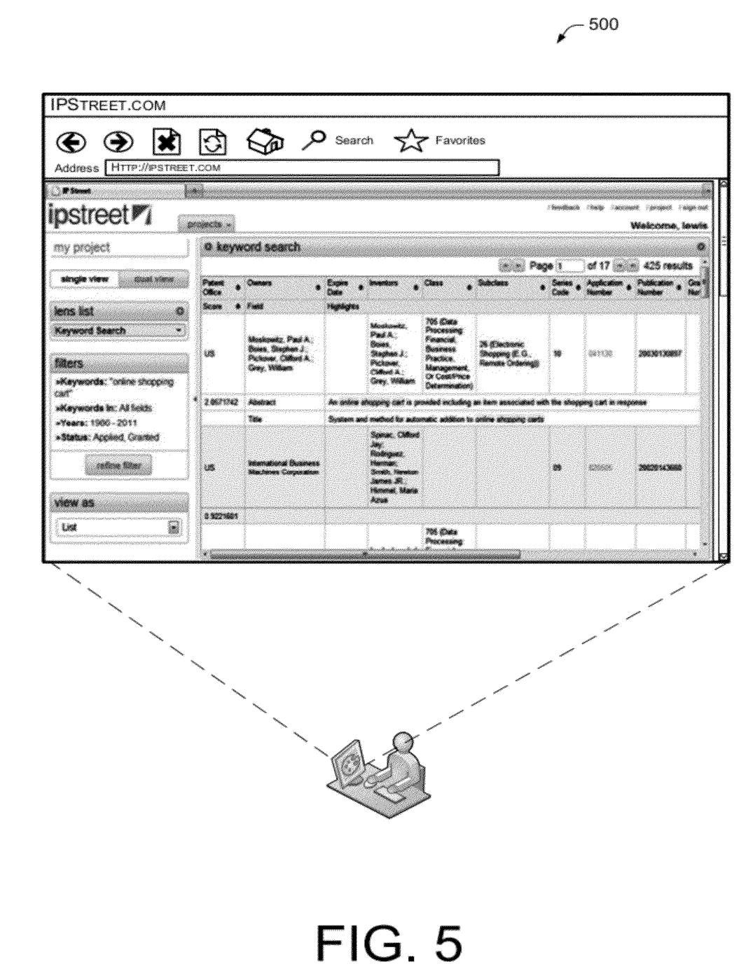

FIG. 5 shows a screen rendering 500 that results from the search of the phrase “online shopping cart” entered into the input box on FIG. 4. The results are presented in a list format that rank orders the patents according to a relevancy score returned by the keyword search engine. Any number of data items for each patent document may be returned, including an owner, a list of inventors, the class and subclass in which the document is classified, serial numbers, publication numbers, grant numbers, an abstract, one more claims, and so forth. Any matches of the input query may also be highlighted to quickly convey relevant portions and why the item was selected. As shown in FIG. 5, a lens entitled “keyword search” has been added to the lens list to show that the user has created a new lens. The user can rename this lens as desired at any time during use of the application.

The list view of the results is just one possible way to view the various patent documents that were identified as satisfying the search query. Depending on the extent of analysis, the search results may be presented in many other ways. In the lower left hand side of the UI 500, the user may select various ways to view this data. Several representative examples will be described below in more detail.

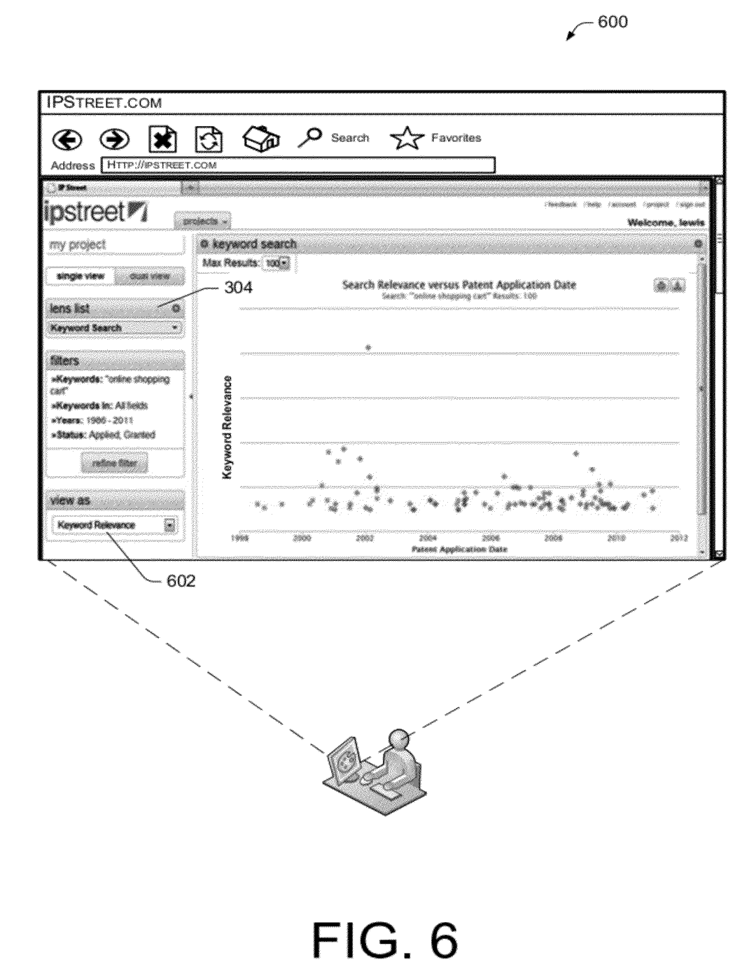

FIG. 6 shows a screen rendering 600 that is presented in response to the user selecting a new way to review the results. In this example, the user has selected to view the results according to keyword relevance. Upon selection of keyword relevance in the drop down menu 602 in the navigation area 304 of FIG. 5, the relevance analysis module 208 (see FIG. 2) processes the results and depicts the results according to a scatter plot as shown. In this view, each patent or patent application is represented by a graphical element or symbol of a same or different color. In this example, applications are represented by orange-colored diamonds, while granted patents are represented by blue-colored squares. The various patents and patent applications are plotted according to their relevance along the y-axis and according to their application dates along the x-axis. The user may select how many results to plot, with one hundred items being a representative default.

As shown in FIG. 6, a scatter plot of various patent documents that are considered most relevant to the keyword input of “online shopping cart” are distributed across the graph. The user may hover a pointer (e.g., a mouse) or finger (if the computing device of the user includes a touchscreen functionality) over any one of the diamond or square elements on the plot to identify specifics about the underlying asset. Moreover, each graphical element is itself actionable and upon selection by the user will allow the user to see the patent document in full. That is, selection of a graphical element on the plot invokes the view patent lens to show a particular patent or patent application.

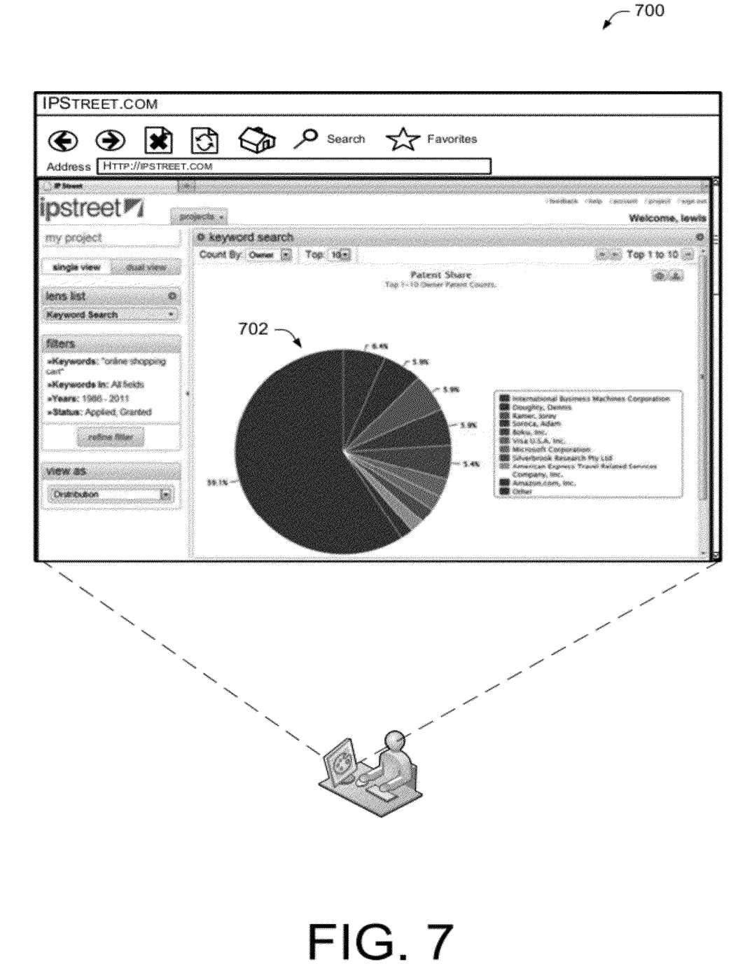

FIG. 7 shows a screen rendering 700 that is presented in response to the user selecting the distribution option for viewing the search results data. In this example, the distribution analysis module 212 (see FIG. 2) processes the results and the distribution of the results about select features is graphically presented as a graph 702 (in this case, a pie chart). The distributions may be computed in any number of ways. In this example, the distribution shows the top ten owners that have patents or patent applications that contain the keyword search phrase “online shopping cart”. These parameters are also user selectable as shown by the two drop down menus above the pie chart. The user may count by other data factors, as will be described below in more detail, or can select different numbers of results to display. At the right hand portion of the results screen, item navigation is provided to allow the user to view next and previous results. For instance, the top ten results are initially illustrated but the navigation allows users to see the next ten results and then the next ten results, and so on. Although a pie chart is illustrated in FIG. 7, other graphical types such as a bar chart may be used.

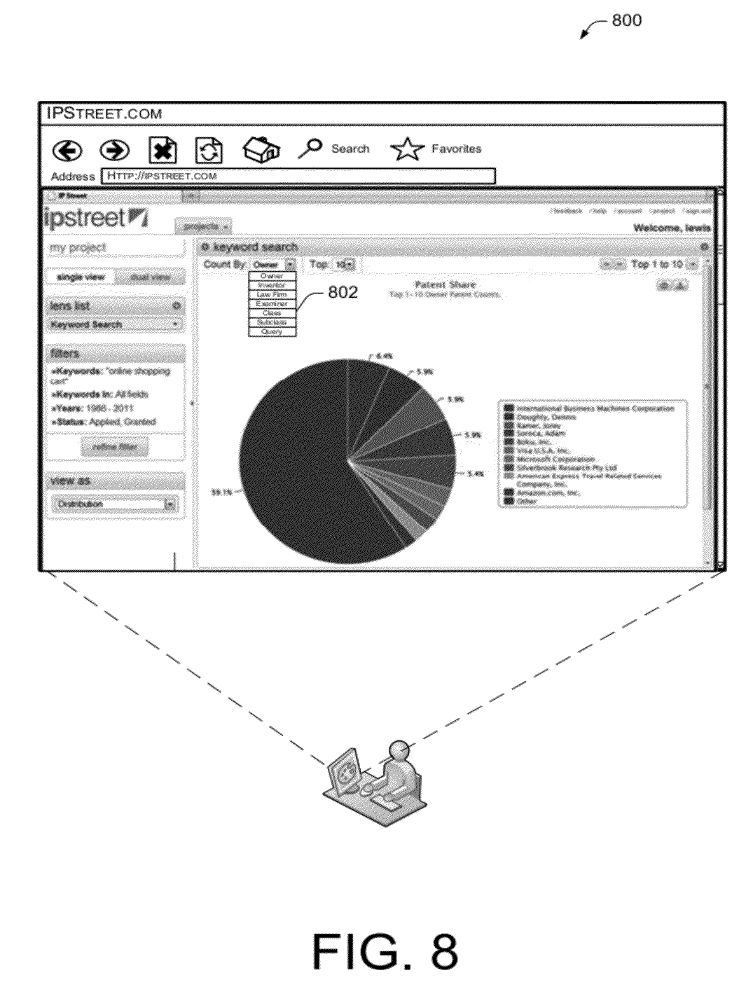

FIG. 8 shows a screen rendering 800 that appears in response to the user selecting the drop down menu 802 to sort the results by other data items to change the results. In this example, other data items that may be used in this distribution view include sorting by inventor, law firm, examiner, class, subclass, and query. However, these fields are merely representative and many other types of data items may be used.

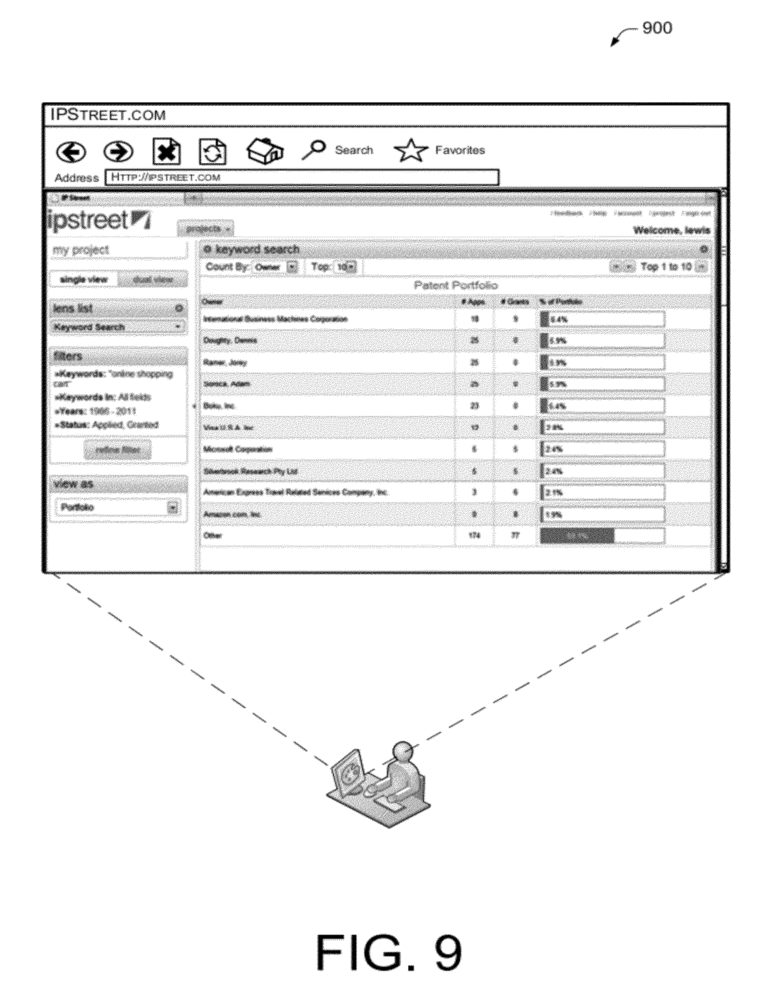

FIG. 9 shows a screen rendering 900 that is presented in response to user selection of the portfolio view in the project navigation space in FIG. 5. The portfolio analysis module 214 (see FIG. 2) processes the results and the portfolio UI 900 shows data items arranged according to a histogram in which particular counts and percentages of the overall portfolio are shown. In this example, IBM Corporation is identified as the top intellectual property owner of patents and applications that include the phrase “online shopping cart”. IBM is shown to have eighteen applications and nine granted patents that contain this phrase and holds 6.4% of the set of patents and applications that contain that keyword phrase. Once again, the user may use the item navigation to see the next ten owners and the following ten owners, etc.

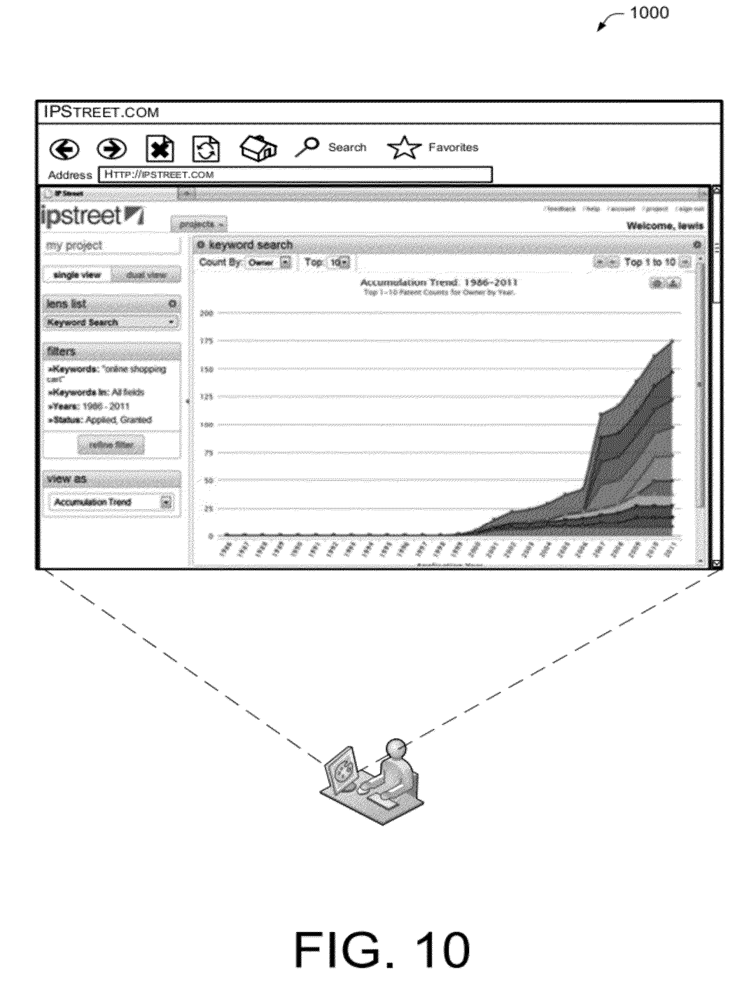

FIG. 10 shows a screen rendering 1000 that is presented in response to the user's selection of the accumulation. In response to the user selecting this option, the trend analysis module 210 (see FIG. 2) is used to compute a trend analysis of the patents having a keyword phrase “online shopping cart”.

The trend UI 1000 shows how the patents and applications which include the keyword phrase were accumulated over time. The trend chart illustrated in this user interface 1000 includes a timeline along the X axis and a count of assets along the Y axis. The results may be visually coded to represent the various holders or owners of those assets. For example, the results may be color-coded or pattern-coded (such as each holder or owner is represented by a different pattern or shading, for example), etc. If the user chooses a different data item to count by, the color-coded sections (as illustrated as an example in FIG. 10) represent the various items under analysis, such as different inventors, different examiners, different law firms, and so forth. As shown in the example therein, the phrase was first used in approximately 1999 and has gone on to be used many times over the years. In this chart showing the accumulation of assets by the top ten owners, by 2011, nearly 175 assets contain that phrase. Another option available to the user is to examine all of the owner records rather than just cycling through the various owner items. In this case, the results would show that the phrase was first used in 1998 with three patent applications including that phrase and by 2011, 425 of the publicly available patents and patent applications contained that phrase.

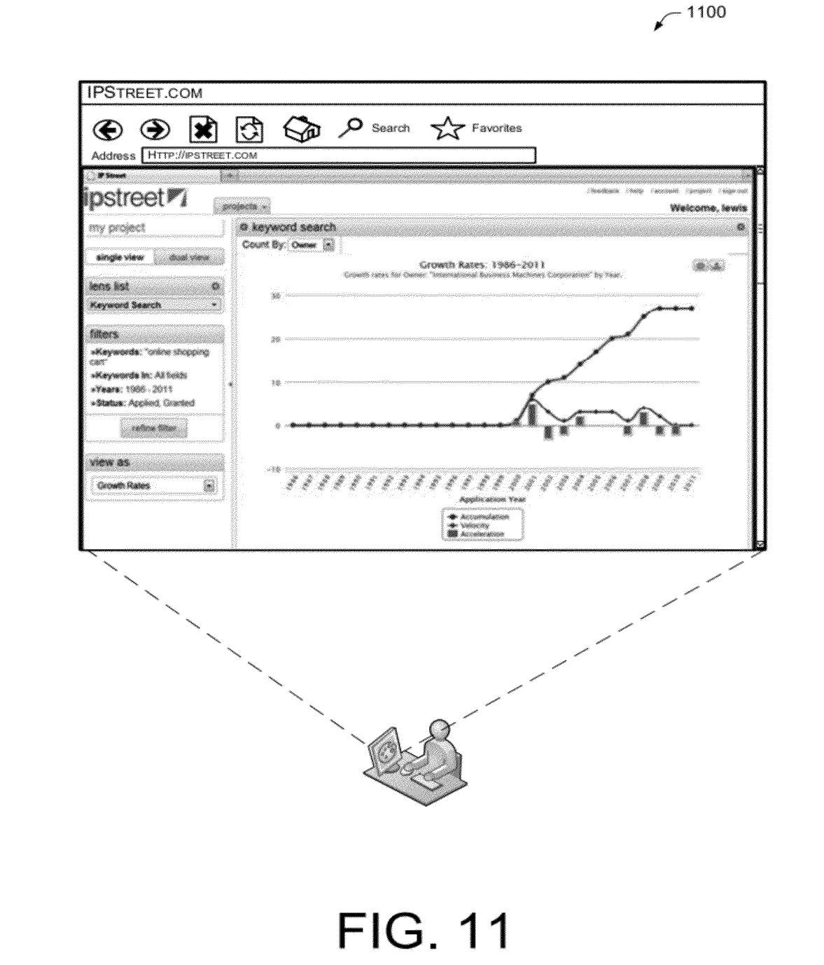

FIG. 11 shows a screen rendering 1100 that is presented in response to the user selecting to view the results according to growth rates. Upon user selection of this view, the growth rate analysis module 216 (FIG. 2) computes velocity and acceleration metrics associated with the patents and patent applications that contain the keyword phrase “online shopping cart”. In this illustrative example, a blue line (designated by circles) represents the accumulation of the top owner, which in this case is IBM, along with the velocity and accelerations rates associated with accumulating IBM's portfolio of patents and patent applications as defined as having the key phrase. Thus, we can learn from this view that IBM has approximately 27 patents and patent applications that have been accumulated since 2000 with bursts of activity happening in 2001, 2004 and 2008. The red line (designated by diamonds) on the chart illustrates the filing velocity, which represents the number of patents filed year over year. The green bars illustrate the acceleration or deceleration of filings in a year over year. Please note that the time periods are an implementation detail and may be configured on shorter time periods or longer time periods.

Returning to FIG. 3, the user may select the statistics lens underneath the “measure” category on the lens list. In response to this selection, the user is once again permitted to define various search ranges in which to measure one or more assets.

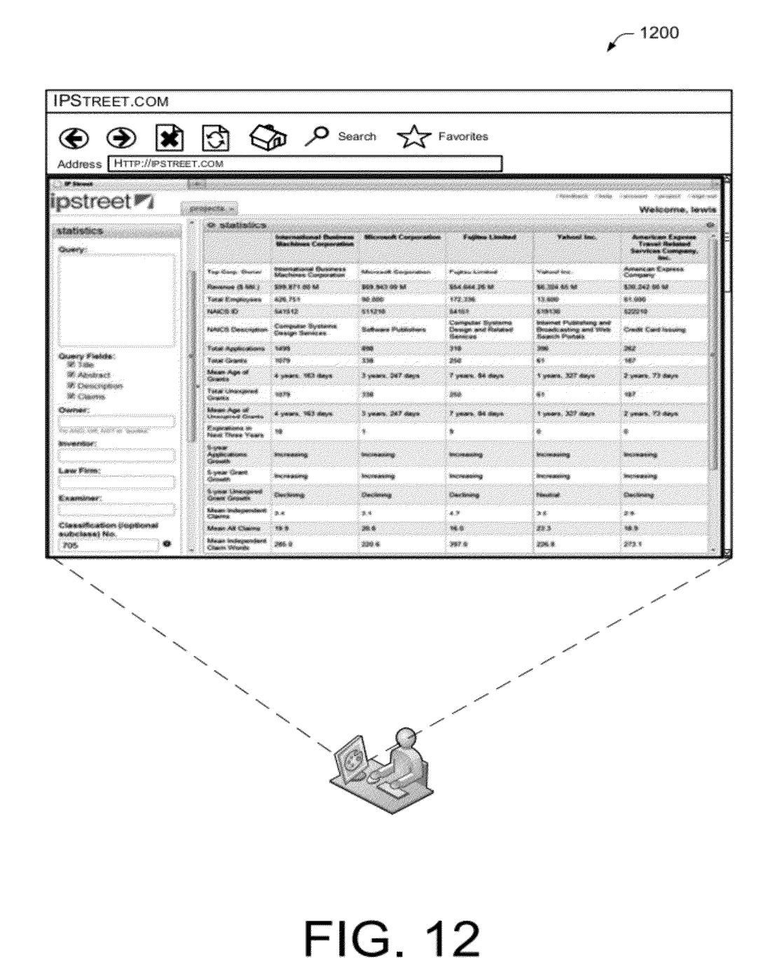

FIG. 12 shows an example screen rendering 1200 that is presented in response to the user selecting the statistics lens on the lens menu of FIG. 3. In the left hand navigation area, the user is permitted to enter any number of items for which to initiate a search. The user may enter a query of one or more keywords, one or more owner names, one or more inventor names, one or more law firm names, one or more examiner names, and/or one or more class/subclass IDs. These data item entries are merely representative, and others may be used. In this example, the user was interested in exploring portfolios in the software Class 705. Upon entry of Class 705, the analysis module 112 (FIG. 2) computes many different metrics used to measure patent and applications whose primary classification is Class 705. The results may be presented in a number of ways. In this illustration, the top five owners of patents in Class 705 are presented in a table. In this example, IBM, Microsoft, Fujitsu, Yahoo, and American Express are presented across the top row of the table. The portions of these companies' portfolios that are found in Class 705 are then measured according to various objective metrics. Among the metrics shown in FIG. 12 are revenue of the company, total employees of the company, a NAICS ID, and a NAICS description. These data items are retrieved from the corporate database and used in this statistics analysis. In addition to this corporate data, data items from the patent database are also extracted and used in various metric computations. An example shown here includes the total applications that the companies have in this particular class, the total number of granted patents that these companies have in this particular class, the average number of the granted patents in this class, the total number of unexpired granted patents in this class, the average age of unexpired granted patents, and patents that are expected to expire within a user-defined or system-defined time period (e.g., within next three years). Further metrics include whether or not this portion of the company's portfolio is growing over a user-defined or system-defined time period (e.g., the last five year trend) and whether its patent applications are growing over the user-defined or system-defined time period (e.g., the last five years). Metrics pertaining to the portfolio itself may also be computed, such as the number of independent claims on average or the number of total claims on average that these companies' portfolios exhibit. More specifically, as one example, IBM is shown to have on average 3.4 independent claims per patent application or patent whose primary class is 705, and on average nearly 20 total claims. Other metrics might include average number of words in independent claims, the average number of words used in the entire patent, the average number of references cited by the patent application or patent, and so on. Many other types of statistical metrics may be generated from a combination of business data and patent data. The examples contained herein are not exhaustive, but many others may be used, such as total number of patents per R&D (research and development) spending, total number of patents per employee, total number of patents per revenue dollar, and so on.

The statistics lens is quite powerful and robust in that portfolios of patents may be defined in any number of ways. For instance, the same metrics can be computed for various portfolios that contain the ongoing example keyword phrase of “online shopping cart”. In addition, users may wish to compare two or more companies' portfolios, either entire portfolios or portions thereof. For example, users may enter two or more owners into the owner entry field and then further define that according to a particular class or according to a particular query and compare various metrics around that portion of their portfolio.

With reference again to FIG. 3, the user may also elect to open a patent portfolio lens under the compare category. Upon selection of this lens, the portfolio analysis module 214 presents a query entry area to allow the user to define what patent portfolio is of interest.

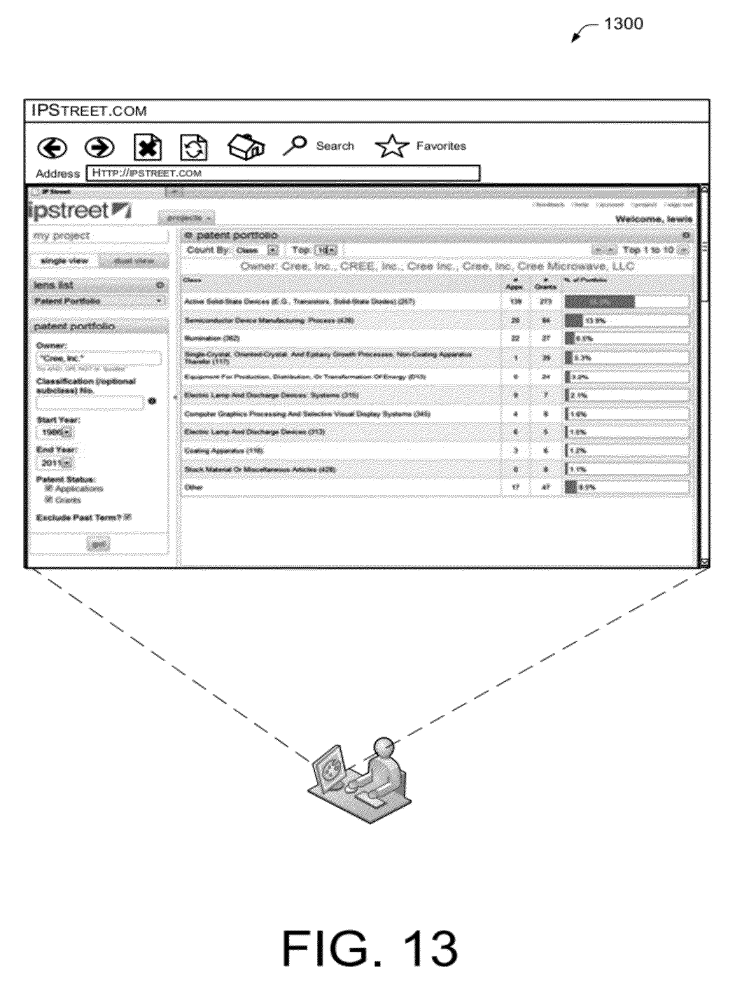

FIG. 13 illustrates a screen rendering 1300 that is presented in response to the user selecting the patent portfolio lens in the compare category. In the left hand navigation panel, the user is permitted to define the patent portfolio in terms of an owner or a particular technology area. In this example, the technology area is defined by the technology classification of the Patent and Trademark Office, for example. It is noted that this is just one example of inputs, and other entry fields may be used to define the patent portfolio.

In this example, suppose the user is interested in examining the patent portfolio of an intellectual property owner (in this example, Cree, Inc.). Here, the user enters the information of the intellectual property owner of interest, i.e., Cree, Inc., into the owner entry field as a search query. Upon actuating the “go” button, In some implementations, the portfolio analysis module 214 may expand the search query to include additional information. By way of example and not limitation, the additional information may include, but is not limited to, common misspellings of the intellectual property owner, abbreviations of the intellectual property owner, divisions of the intellectual property owner, subsidiaries of the intellectual property owner, a parent entity of the intellectual property owner, acquisitions by the intellectual property owner, and/or alternative names of the intellectual property owner. In some implementations, the portfolio analysis module 214 may perform a search and/or present information of an intellectual property portfolio of the intellectual property owner based on the information of the intellectual property owner and the additional information. For example, the portfolio analysis module 214 computes the patent and application data that names Cree, Inc. as the assignee. Screen rendering 1300 shows Cree's portfolio broken down by various classes. As shown in this example, Cree has 55% of its portfolio in the Active Solid State Device Class 257. The next largest technology class is 438, or Semiconductor Device Manufacturing, in which Cree has 13.9% of its portfolio. While the example illustrates use of the PTO classification system for the taxonomy, other taxonomies may be used, including proprietary taxonomies that might be developed by Cree itself. In essence, this view shows a top level or first tier look at Cree's patent landscape. However, the user may drill down and see a second tier of the patent landscape through use of this patent portfolio tool. In particular, the user may identify a particular class of interest and enter that classification number into the classification entry field in the left hand panel. For example, suppose the user is interested in the illumination technology currently in Class 362. The user may enter Class 362 into the classification entry field and then sort the results by subclass.

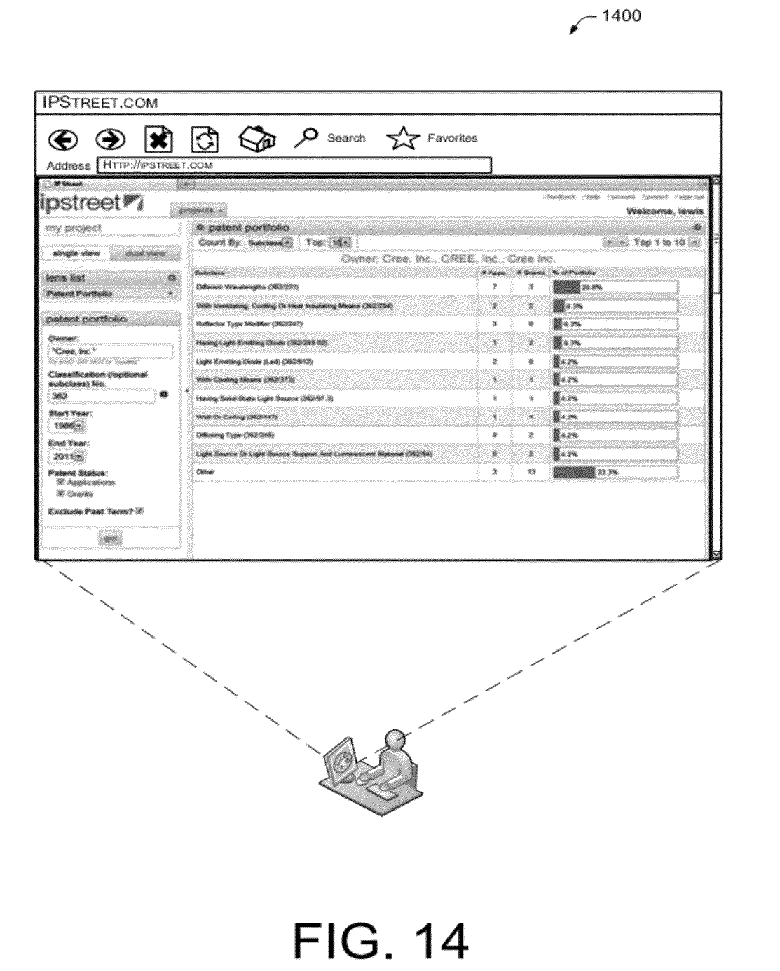

FIG. 14 shows a screen rendering 1400 that is presented in response to entry of a particular class and then sorting by a subclass to reveal a second level of a taxonomy-based landscape. In this example, Cree has ten assets in the class of “illumination” and subclass of “different wavelengths.” Accordingly, through this patent portfolio lens, the user is able to get a high overview of the company's portfolio followed by the ability to drill into portions of that portfolio for a more detailed or granular view. With multi-tier taxonomies, the patent portfolio lens allows users to drill as deep as desired.

With reference again to FIG. 3, the user may also elect to open the inventor's lens from the “connect” category. In response to this selection, the analysis module presents a query entry field for the user to define a collection of assets across which to analyze key inventors.

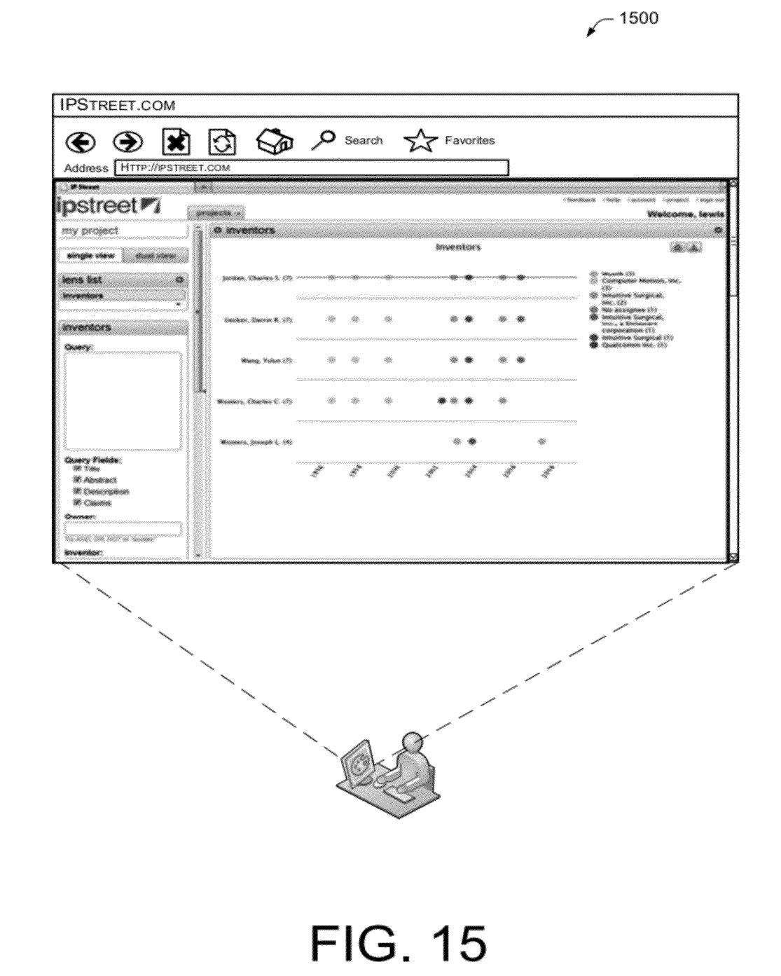

FIG. 15 illustrates a screen rendering 1500 that is presented in response to user selection of the inventor lens in the project menu 300 of FIG. 3. The user may enter a query, an owner name, an inventor name, or any number of parameters to narrow a selection of assets from which key inventors can be analyzed. In response to the user input, the analysis module computes the records to identify the top inventors in those records and then presents a view in which inventors are organized along a Y axis and a timeline is arranged along an X axis. Each asset associated with a particular inventor is then plotted to show the entire inventive history of that inventor. In this example, the inventor Charles S. Jordan is shown to have seven patents and/or applications with the first application being filed in 1996 and the last one being filed sometime around 2007. Each circle associated with an inventor represents a patent or patent application. Each circle may be visually coded (e.g., color-coded or pattern-coded, etc.) to identify a corresponding assignee for that particular patent or patent application. In some implementations, the size of each circle may also be adjusted based on the scope of the broadest claim of that particular patent or patent application as determined by the claim scope engine 220, for example. By arranging the assets according to timeline, we can also glean intelligence as to whether any of these inventors have worked together across these inventions. For instance, it appears that the inventors Charles S. Jordan, Darrin R. Uecker, Yulun Wang, and Charles C. Wooters were all named on a number of patents as co-inventors, as evidenced by the same assets being vertically arranged at the same time. The inventor lens may be used for a number of different scenarios, including being able to identify other people for potential collaboration, for due diligence in many situations, or even for recruiting purposes.

With reference to FIG. 3, the user may also elect other lenses in the “discovery” category. For instance, the user may elect the concept scatter plot or concept search lenses to conduct concept searches of the patent and business data.

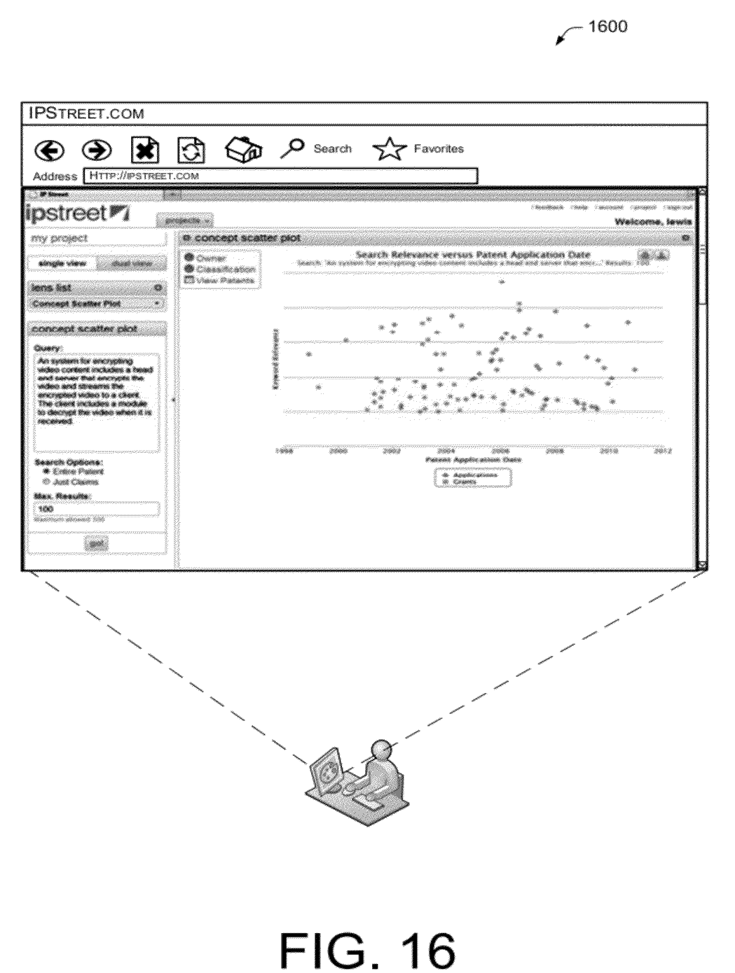

FIG. 16 shows a screen rendering 1600 that is presented in response to the user selecting a concept scatter plot search lens from the lens menu in FIG. 3. Upon selection of concept scatter plot, the user is prompted to enter a concept into the query space. As opposed to entering one or more keywords, the user is allowed to enter a much more detailed explanation of a concept. In fact, the user may be encouraged to enter an entire paragraph or page or more of content in order to define the concept of interest. In this example, a short paragraph of multiple sentences is entered into the query space. Once the query is entered, the user may actuate the “go” button or other control to initiate the concept search engine to query the database based on the input concept.

The concept results page 1600 illustrates the result of this concept search. Once again, individual symbols or graphics of a same or different color may be used to identify individual patents and/or applications. As an example shown in FIG. 16, orange diamonds are used to represent corresponding patent applications and blue squares are used to represent granted patents. These assets are distributed in a two dimensional plot having relevance along the Y axis and filing date along the X axis. The concept search engine returns a relevance score used in this visualization. In one particular implementation in which an LSI-based concept search engine is used, the relevancy scores are between 0 and 1 with 1 representing 100% relevance and 0 representing no relevance. The number of results returned is a user configurable parameter.

The user may point (using a mouse or finger, for example) over various items in the plot to view individual documents. As before, each item is itself actionable, and upon selection by the user will present the corresponding patent document. In addition, the concept scatter lens includes a local menu in the upper left hand corner of the results panel which may be used to pivot some of the data. In this example, the user may identify the top owners of the patents and/or patent applications that were returned, identify what classifications most of these assets are classified in, or view a full list of all the patents and/or patent applications that were returned by the concept search engine. Assume for discussion purposes that the user would like to see what other companies are interested in this technology by selecting the ownership link.

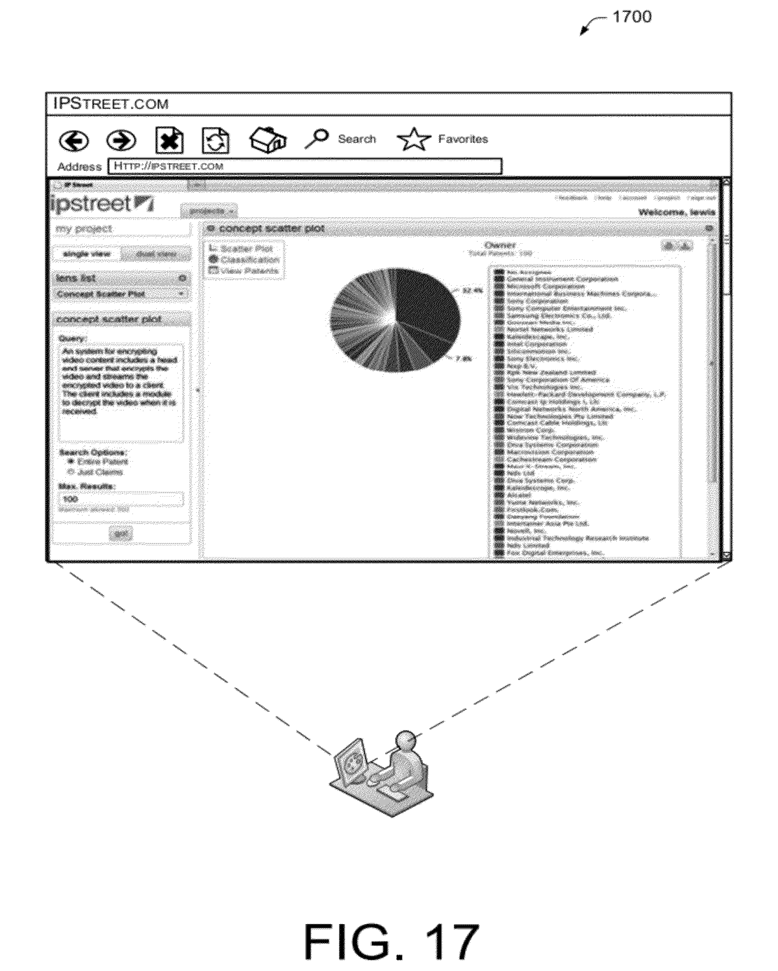

FIG. 17 shows a screen rendering 1700 that is presented in response to the user selection of the ownership link in the concept search results panel. As shown in FIG. 17, a list of owners is presented in a graphical form (e.g., a pie chart image, a bar chart image, etc.) to identify the top owners of the assets returned in this concept search.

Returning to FIG. 16, the user may elect to view any number of these items by simply selecting the particular symbol or graphics. Upon selection of that symbol or graphics, the underlying asset will be presented.

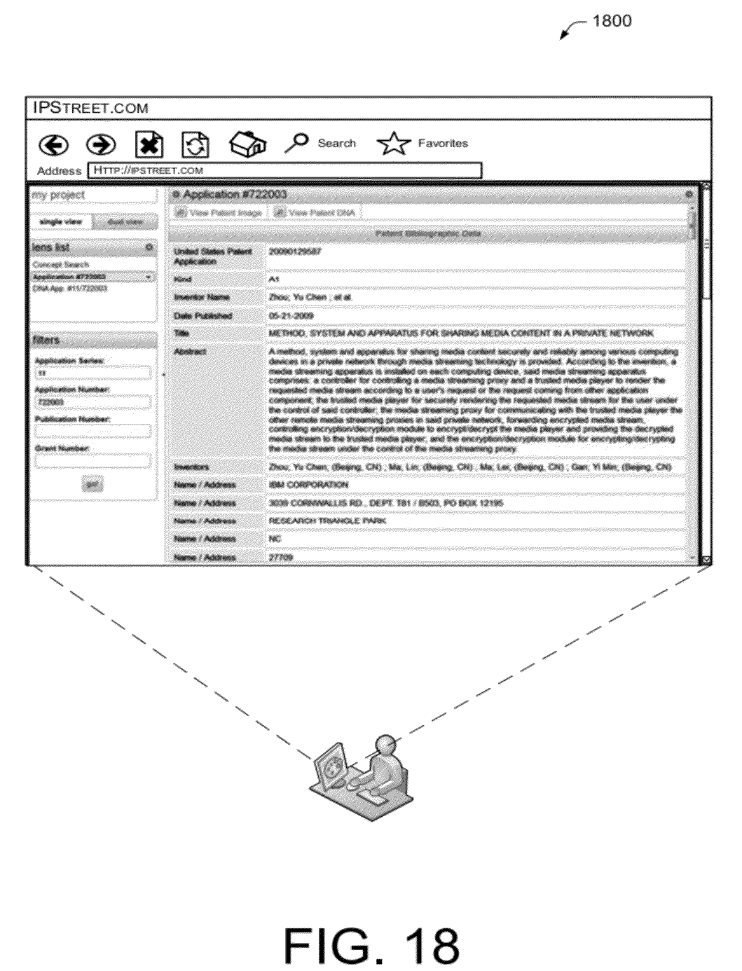

FIG. 18 shows a screen rendering 1800 which is presented in response to user selection of a particular symbol or graphics in the concept plot of FIG. 16. In this illustration, the application number, date of patent, title, abstract, and inventors are shown. The user may scroll down to see the entire patent application. In addition, a “view patent image” UI button is provided that enables the user to view the patent as issued and printed by the U.S. Patent and Trademark Office or the patent application. Also, a “View Patent DNA” UI button is also provided to enable a user to view quality assessments of the illustrated patent or the patent application. Suppose, for example, the user selects the “view patent DNA” UI button.

FIG. 19 shows a screen rendering 1900 which is presented in response to user selection of the “view patent DNA” UI button of FIG. 18. Screen rendering 1900 includes a graphical depiction of individual claims of the patent or patent application as selected relative to other claims in a collection (e.g., a common technology area, classification, set of search results, etc.). In this example, the screen rendering 1900 shows a two dimensional graphic that is referred to as the ClaimScape™. In this view, the four independent claims of the patent application Ser. No. 11/722,003 are plotted in a two dimensional graph in which claims that are comparatively narrower than other claims would align closer towards the lower left corner or origin and claims which are comparatively broader than its peers, and their peers are shown in the upper right hand corner of the chart. The ClaimScape™ view of rendering 1900 is plotted based on values returned by the claim scope engine shown above in FIG. 2. Namely, each individual independent claim is assessed using statistical analysis and algorithms that examine and ascertain the relative scope of the individual independent claims relative to all other claims against which they are being assessed. In one particular implementation, these four claims are being assessed relative to all the other claims that show up in the primary class to which the patent application is classified. In this example, the application Ser. No. 11/722,003 is assigned to the U.S. Class 380 (Cryptography). Accordingly, the four claims, as represented by four dots in the chart, are assessed relative to all other independent claims of all other patents in Class 380. In other implementations, the grouping of patents against which these claims are compared may be based upon international codes, such as IPC classification codes, or subclasses, or essentially any collection of patent documents. More relevant results are obtained when the patents to which the claims are being compared are generally within the same technology areas.

The ClaimScape™ image plots claims according to two vectors along the x and y axes. These vectors are based on assumptions that are generally accepted by the patent community. The first assumption is that, generally speaking, claims that use fewer unique words tend to be broader than claims that use more unique words. More plainly, shorter claims tend to be broader than longer claims. The second vector is based on the assumption that claims that use more commonly used words in a particular class or collection of technology tend to be broader than claims that use less commonly used words. By mapping based on these two underlying assumptions, even shorter claims may be ranked not quite as broad if they use terms that are considered limiting or distinctive within a class in which the ontology is well developed. The claim scope engine computes values for each of the independent claims based on the number of unique words found in each claim, and how frequently those words happen to appear in all the claims in all the collection of patents to which they are being assessed (e.g., a single class). More specifically, the architecture stores all of the patents claims in every patent throughout the database and computes for each of those patents a total word count for each claim, a total count of unique words used in each claim, the number of times each of those words appears in the collection of patents to which the claims are being assessed (e.g., a class of patents), and may use word stems or bigrams or trigrams or other ways to evaluate individual words or phrases of the claims. The claim scope engine computes these vectors based on functions of unique words and frequencies of those words found across all claims and within individual claims to develop coordinate values in which to plot these dots on the ClaimScape™ view.

Various bands are added to graphically show how the individual claims compare across the entire collection of claims. In one example, the bands may be color coded. In one implementation, each band might represent a particular quartile of scope in which claims lying closer to the origin or the narrower part tend to be in the lower (labeled “Low” in the figure) quartile and claims falling in the outer band closer to broad category label are in the upper (labeled “Top” in the figure) quartile. Claims falling between the lower and upper quartiles are illustrated in the band labeled “Mid” in the figure. There are many other ways to graphically illustrate this, however.

Each point on the ClaimScape™ graph may also have an associated distance from the origin. This distance value is based on the x and y components using a conventional Pythagorean theorem for right triangle computation. In this manner, each independent claim in every patent within a collection of patents such as all patents in a particular class, have an associated distance value. This enables the system to rank order patents relative to one another in terms of claim scope or breadth. Hence, other UI representations previously discussed may use this distance value to alter the appearances or to provide another factor in which to sort or rank the patents and applications according to claim breadth.

As noted above, each point on the ClaimScape™ graph of rendering 1900 represents an associated independent claim. A legend is show to the right of the plot to identify which independent claims are being depicted. The user may select (e.g., hover over) any individual claim point to see part or all of the claim.

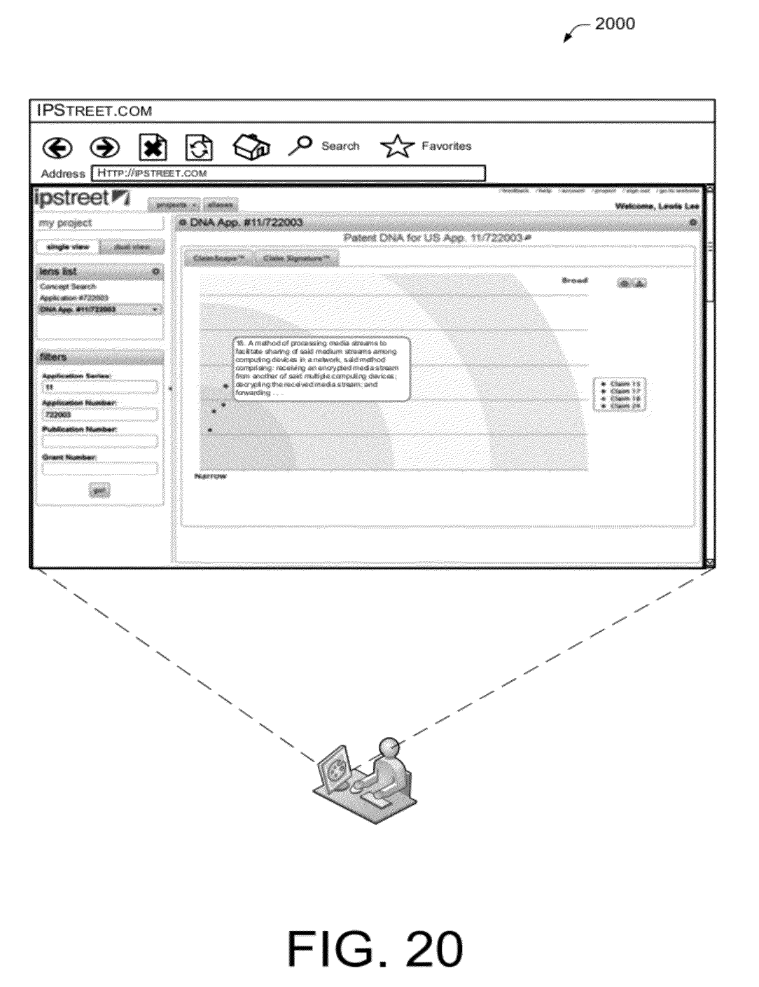

FIG. 20 shows a screen rendering 2000 in which the user has selected (e.g., hovered a pointer above) a particular dot on the ClaimScape™. In response, a graphical pane appears on the screen and contains all or part of the claim language for that claim. Next, suppose the user moves to the tab entitled “Claim Signature™” on the screen rendering 2000 and activates that tab.

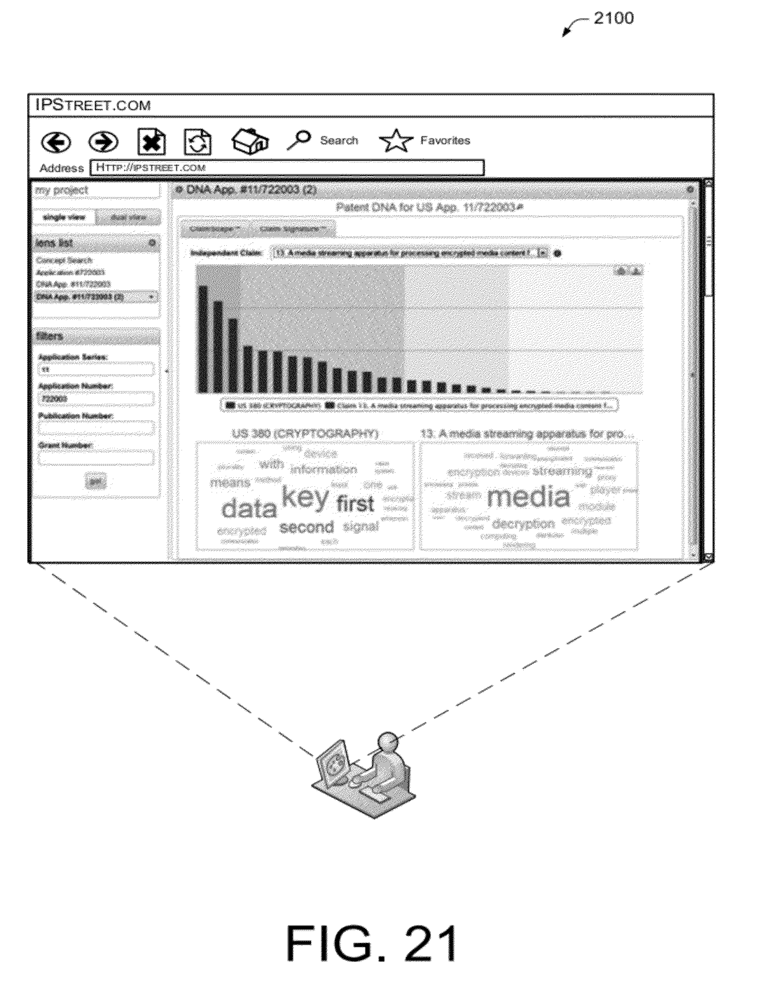

FIG. 21 shows a screen rendering 2100 which is presented in response to user selection of the Claim Signature™ tab in FIGS. 19 and 20. In this screen rendering, there are three panels or areas of the display area that show various metric features used in deriving a claim signature. The graphical outputs shown in screen rendering 2100 are provided or generated by the claim signature engine of FIG. 2. The first pane in this Claim Signature™ view is a histogram or distribution of words found in the claim itself. In this example each word in the claim is represented by a bar, where each bar is scaled or sized according to the number of times the word appears in the entire set of claims, such as all the claims in a particular U.S. classification. In this manner, the more commonly found words in a particular class or collection of patents is shown to the left and less commonly used words in that particular technology class are shown to the right. In one example, color coding, pattern coding or other visual coding may be used to show different sectors. For example, darker color codes along the left may be used to imply that those words are found in the most common quartile of words in that class, whereas a lighter color quartile out towards the right may be used to represent the least commonly found words. The particular claim to which those words pertain is shown above the graph. A pull-down menu or other control allows the user to select any one of the independent claims within that particular patent or application.

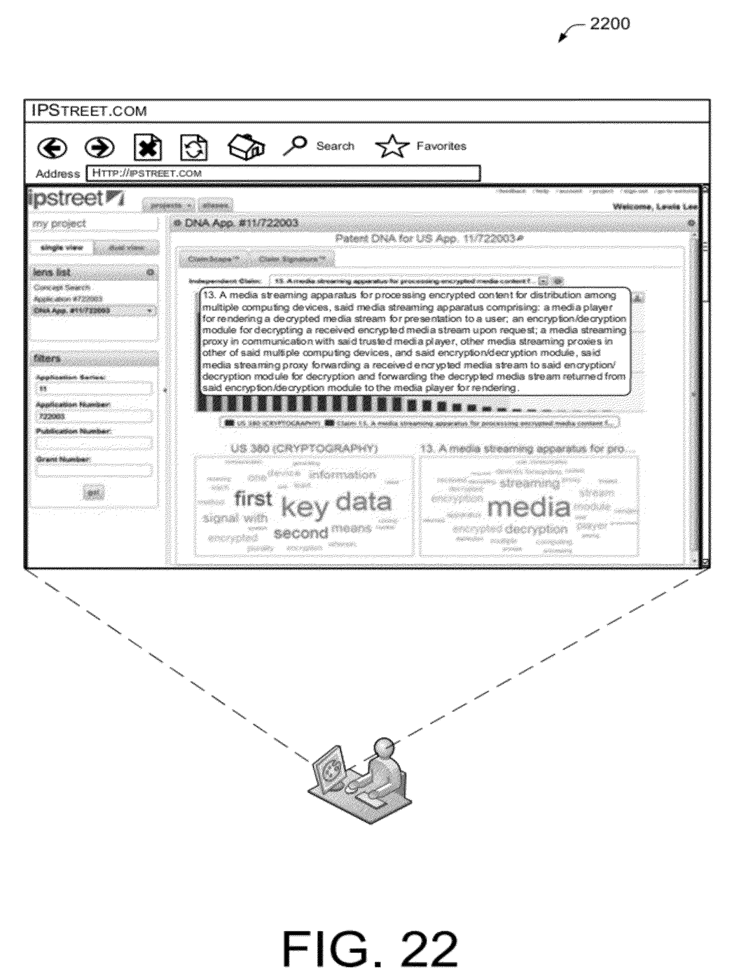

FIG. 22 illustrates an example screen rendering 2200 in which the user has selected (e.g., hovered over) an icon adjacent to the pull-down menu to illustrate the claim that is being considered in this graph. This allows the user to see specifically what words are in the claim and how the words are arranged. The user may select any one of the independent claims from this application and identify and review each of the claim words and the claim structures that are different for each claim.

Beneath the distribution plot are two panes that include word clouds. The left hand word cloud shows words that are commonly found in the entire collection of claims, such as all the most commonly found words in a class of patents. The right hand word cloud shows the words that are most frequently used within this particular claim. In this example, the word “media” is the most frequently used word in this claim. In other implementations, the right hand word cloud may also show an inverse word cloud wherein the most uncommon word or the one found the farthest to the right in the distribution actually appears as the largest word in the word cloud.

The distribution represents a unique signature in which this collection of words from the class is uniquely assembled to form a unique claim. Searches may be performed to find other claims that are relevant to this claim by looking at slight variations in the words used. This is yet a separate form of search across patent documents independent of keyword search and concept search. The less commonly used words out toward the right hand side of the distribution tend to be correlated to words that give each claim its distinctiveness and hence its novelty or patentability. Accordingly, understanding which words those are provides some meaning to the practitioner or user who is interested in better understanding why this particular claim may have been allowed.

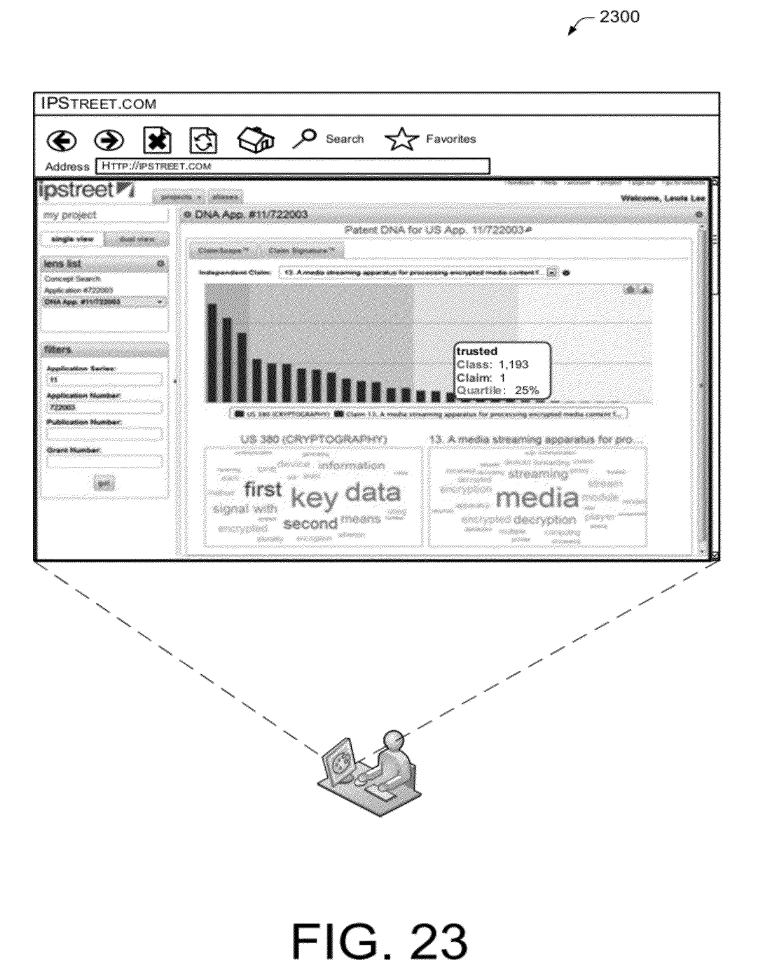

FIG. 23 shows a screen rendering 2300 in which the user has selected (e.g., hovered or pointed over) one of the bars on the distribution curve to look at a unique word. In this particular case, the user has hovered over the first bar in the first quartile to reveal that the word “trusted” is found in this particular claim 13. Upon hovering the associated bar in the bar graph chart, a pane is presented to show that the word “trusted” occurs 1,193 times in the class and one time in this particular claim. The user may move along the claim signature identifying an associated word with each bar and how frequently that word is found in the class and in the particular claim.

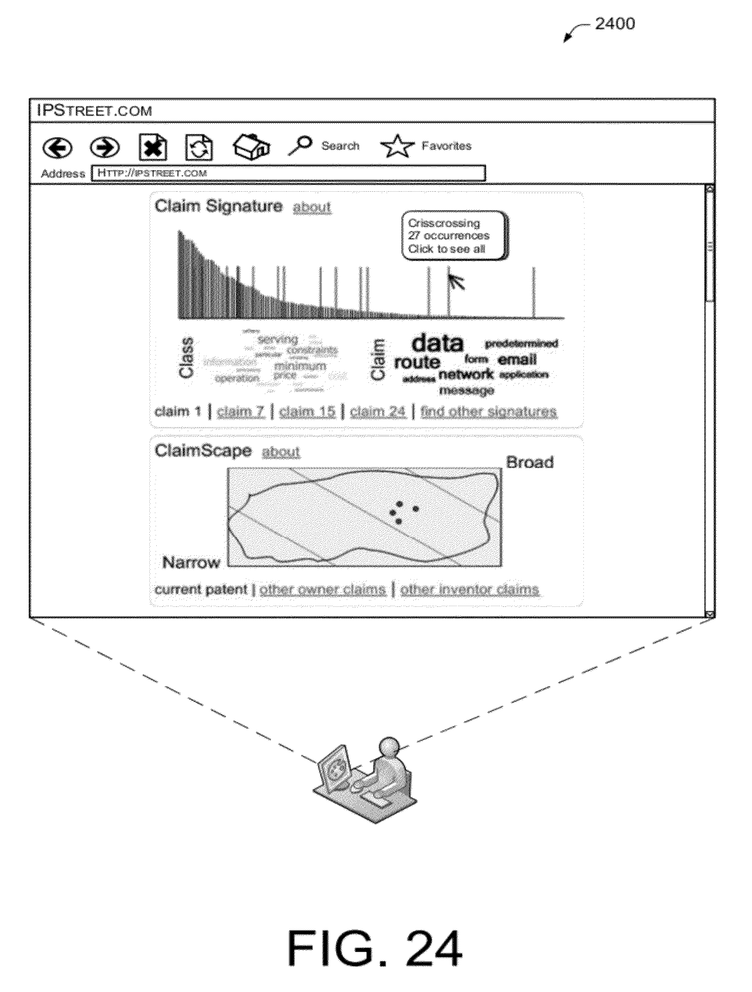

FIG. 24 shows a screen rendering 2400 of another illustration of the ClaimScape™ and Claim Signature™. Of particular interest, Claim Signature™ shows a word distribution of a class where each individual vertical dark line shows relative frequency of each word potentially appearing in that class. In one implementation, this type of word distribution of a particular class (such as a classification of a taxonomy, for example) may be determined based on a corpus of patents and/or patent applications selected for that particular class, for example, claims of patents and/or patent applications that are classified to belong to that class. Additionally, this corpus of patents and/or patent applications may be collected or found using any selection method as described in the foregoing implementations, such as selecting patents and/or patent applications that are filed or published within a predetermined period of time (e.g., between Jan. 1, 1990 and Jan. 1, 2010, etc.) in that particular class, selecting patents and/or patent applications that are owned by one or more intellectual property owners in that particular class, and/or selecting patents and/or patent applications that are returned by the search engines 110 based on one or more keywords or concepts, etc. In some implementations, the selected corpus of patents and/or patent applications for the class may be fixed, regularly updated after a predetermined time interval, or continuously evolved as new patents and/or patent applications are found. Furthermore, the word distribution of a particular class may be determined in advance or on the fly when the user wants to determine a claim signature of a claim that is within the particular class. A second vertical mark, shown in red (the vertical lines having uniform height in FIG. 24) for example, identifies each word used in a particular claim. Alternatively, the second vertical mark may have a height depending on a respective occurrence frequency of the word in that particular claim. In this way, the claim word marks of the particular claim appear to be similar to a barcode (having a uniform height or varying heights for its vertical marks) in which the claim word marks are spaced according to how the actual words are used in the claims of the corpus of patents and/or patent applications used or collected for that class. In this example implementation, relevancy of a first claim with respect to a second claim may be computed or determined based on correlation between respective barcodes of these two claims in this example representation of claim signature. This is a slightly different representation than the one in FIG. 21 in which only the bars for the words which are commonly in the class and in the claim are shown, and the difference of the red marks (i.e., those having uniform height).

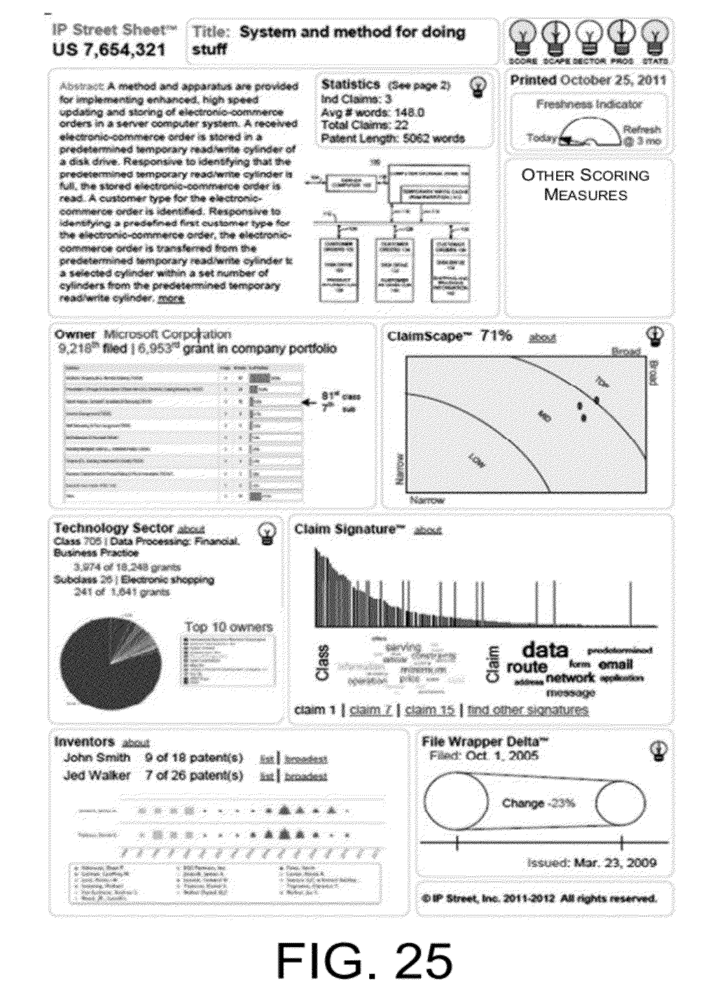

FIG. 25 shows a graphical sheet that may be presented on a computer display or printed on a single piece of paper that contains several of the images and graphs discussed in this document. This output, identified by the trademarked name IP Street Sheet™, shows a collection of analysis tools pertaining to common input, such as an individual patent or application. In other implementations, the common input might be an owner, inventor, examiner, law firm, or the like.

When presented on a graphical display, each component shown in this display is fully interactive, allowing the user to select, move and pursue other links therein. A title is shown at the top of the output. Adjacent to the title is a metric indicator consisting of five light bulbs. Each light bulb is associated with a quality metric somewhere on the output. Each light bulb may be on, half on, or off, thereby enabling 125 grading variations. The patent is deemed of increasingly higher value as more light bulbs are turned “on”. On the left hand side is a space for the abstract of the associated patent or application. Along with that abstract is a potential figure that provides a high level summary of the asset. Within that space, there may also be a window for statistics of the patent or application. These statistics may be any number of metrics that can be found and generated by the statistics engine described and discussed above. Beneath the light bulbs metric is a freshness indicator which identifies when the data was first output and when it should be refreshed. Since new patents are granted and new applications are filed every week, the metrics become stale over time. The freshness indicator may be based, for example, on filing rates within a particular class. Beneath the abstract is a portfolio view of the owner of this patent and where this patent lies in that portfolio. The owner of the asset, if known, is shown and the full or relevant portion of the owner's portfolio is shown. The position of the asset (patent or application) within the owner's portfolio is also provided. Beneath the owner portfolio is a technology sector output that provides the relative placement of the patent or application within the class or subclass. It also provides the top ten owners of patents/applications in that relevant class. At the bottom left of the output is the inventor information where there inventors identified on the particular patent or application are listed and a visual graph of all of the inventor's patents/applications are plotted along a timeline with identification of the owner's of those patents/applications. Along the right hand side of the sheet are three outputs including the ClaimScape™, the Claim Signature™, and the file wrapper delta. The ClaimScape™ and Claim Signature™ have been described above. The file wrapper delta is another output which attempts to measure the change in claim scope as a result of prosecuting the patent from the time it was filed to the time it was issued. The scope change is a function of the ClaimScape™ metric. That is, the claims of the application, if available, are processed by the claim scope engine with the broadest claim being identified. The independent claims of the granted patent are also processed by the claim scope engine to identify the broadest claim. The variation from the broadest published claim to the broadest granted claim is then calculated and visually depicted to show a change in scope. The filing dates and issue dates are also provided to give the user an idea of how long it took to prosecute that case.

### Illustrative Scenarios

With reference again to FIG. 2, the IP-based business intelligence service 102 also supports various scenario wizards that allow users with little or no IP experience to glean business intelligence from the underlying patent documents. Several wizards are illustrated in FIG. 2 along with a brief description of each of those.

The claim language evolution wizard allows a user to identify how claim language has evolved over time. For instance, suppose a user is interested in identifying when the phrase “online shopping cart” was first used in a claim. The user can enter that query into the keyword search and then view the results according to the keyword relevance plot. This will show when it was first introduced and all subsequent uses of that phrase over time. It is noted that other views may be used, but one advantage to the relevance scatter plot is that the user can quickly see whether that phrase became more commonplace over time. For instance, the phrase “online shopping cart” was first introduced in 1998 and was used sparingly in the first several years. Thereafter, as that phrase became more commonplace, more and more claims were shown to have that.

The taxonomy-based landscape scenarios leverages the patent portfolio lens to enable users to see multi-level views of a patent landscape, For instance, with this wizard, a user may simply enter a company name and be able to see multiple levels of its landscape. As shown above with respect to FIGS. 13 and 14, a user could simply enter the corporate name “Cree” and be presented with multiple levels of landscape analysis in and around the portfolio assigned to Cree.

The freedom to operate wizard leverages the power of the concept search engine to evaluate whether or not a product idea would be at some risk of infringing other people's rights. The user may simply open a concept search lens, and enter a description of the product that is to be released. The description may be as general or detailed as the user desires. Once entered, the concept search engine evaluates the concept contained in that product description against the claims of all the patents in the entire patent database. That is, concept index was built using only claim language and not the entire document as one option to enable this freedom to operate exercise. The user may then view the patents returned in this result to determine whether or not there is some exposure to infringement if this product were to release. In other implementations, the user may choose to refine their description of the product in an effort to continue to design the product in ways that might avoid infringement in the future.

A validity analysis wizard may also be provided to enable users to do some validity screening. A validity wizard leverages the power of concept search to examine all patents that may be relevant to the validity of one or more claims. With this wizard, the user is prompted to enter a claim of a particular patent or patent application. The wizard then extracts the full claim language, enters it into the concept search, and conducts a search across the entire patent document of all documents in the database that predate the earliest priority date associated with the subject patent. As a proxy, the priority date is assigned to the filing date, but the user may adjust that. The results returned are all patents that predate the priority date and are deemed relevant to the concept cited in the particular claim of interest. From this, the user may determine whether or not that claim is likely to be held valid or invalid.

The find a licensee wizard may leverage either the keyword or concept search engines to identify other companies or people who are interested in the particular technology space of interest. Upon conducting a search, the results may be pivoted according to ownership to identify potential candidates that may have interest. In some implementations, both concept and keyword may be used to provide more robust results in order to get a short list of potential inventors and/or companies that are participating in this particular space.

These results may also be compared to results from the growth rate analysis to see whether or not any of these companies are recently accelerating their filings in a particular space. Upon finding owners or assignees that (1) have bona fide interest in this area, and (2) tend to be accelerating filings in this area, this provides a good list of potential licensees who may be interested in the user's patent or patent application.

### Exemplary Methods

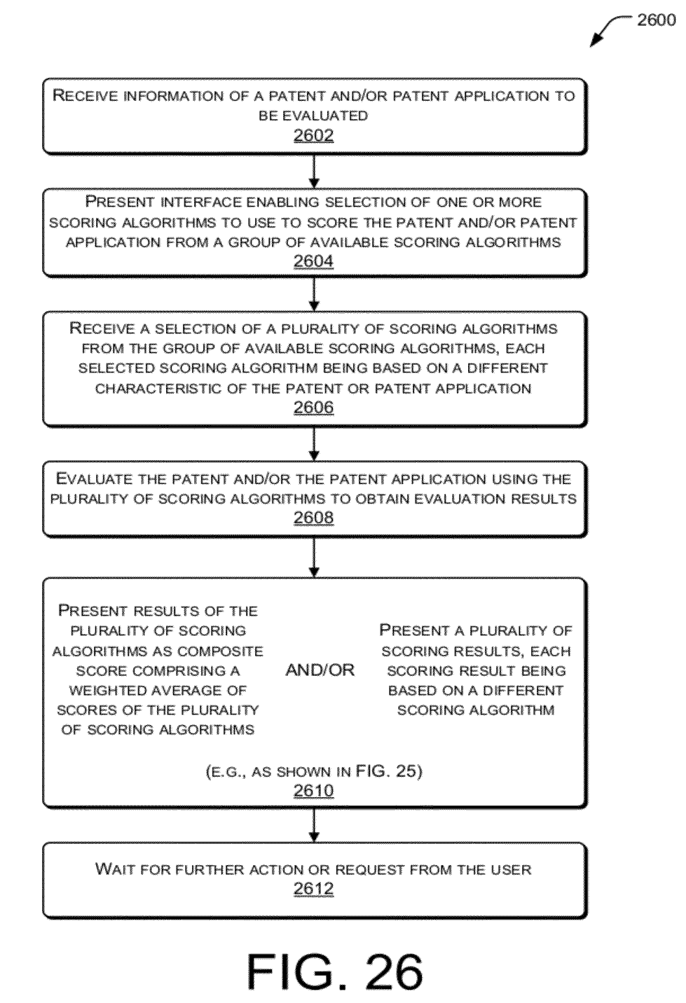

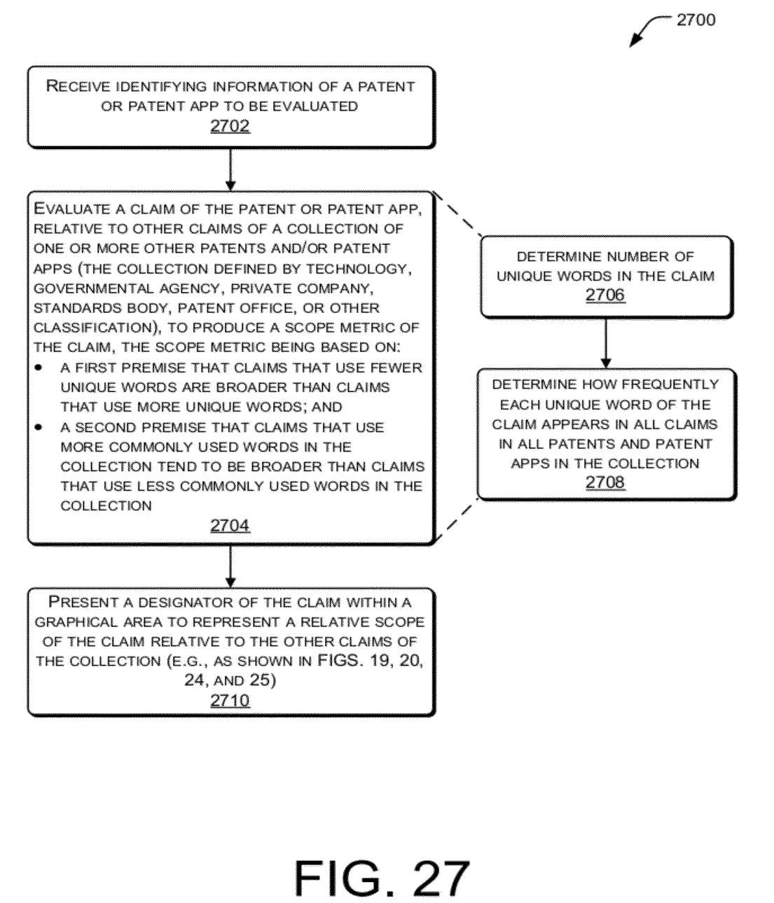

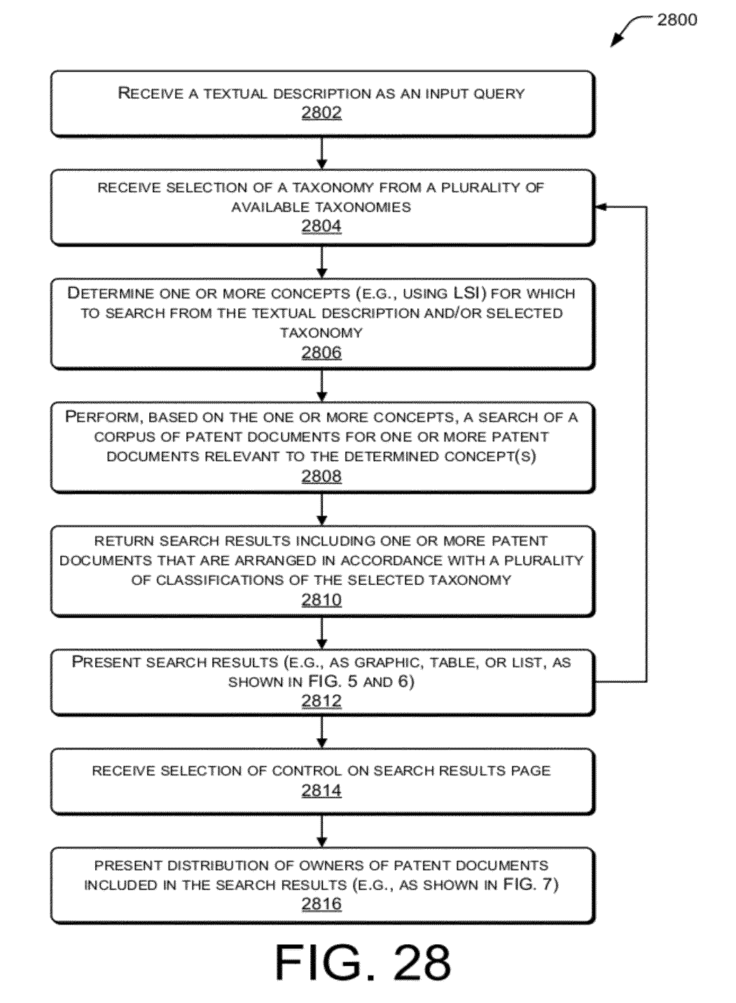

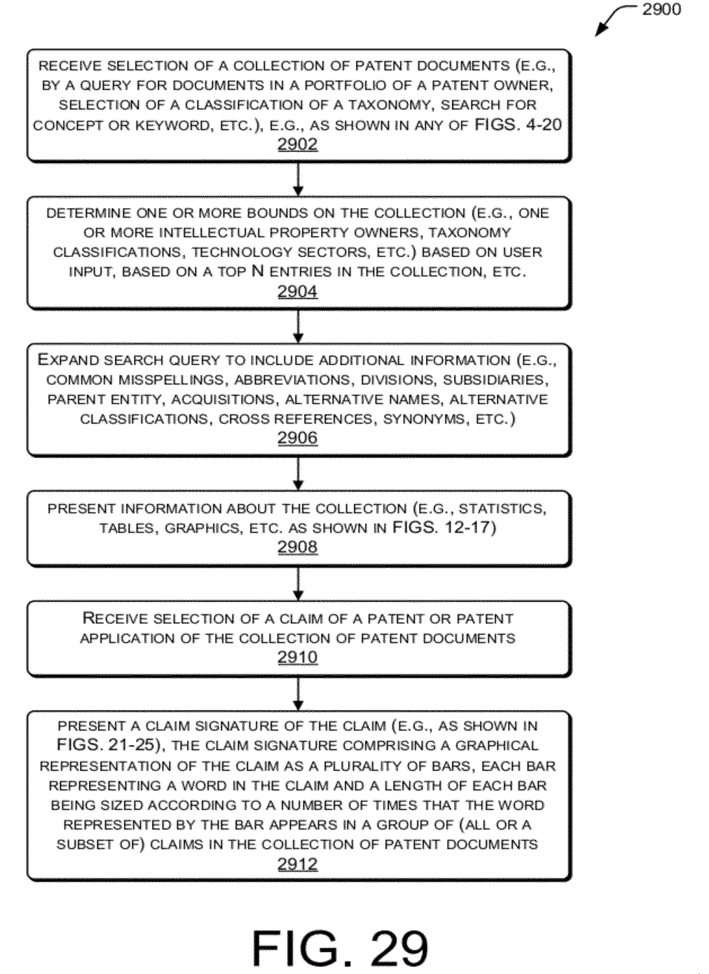

FIG. 26 is a flowchart depicting an example method 2600 of evaluating a patent and/or a patent application using a plurality of scoring algorithms. FIG. 27 is a flowchart depicting an example method 2700 of determining a scope metric of a claim of a patent or a patent application. FIG. 28 is a flowchart depicting an example method 2800 of performing a concept search for patents and/or patent applications based on a taxonomy selected from multiple available taxonomies. FIG. 29 is a flowchart depicting an example method 2900 of determining and analyzing a patent portfolio of a patent owner or assignee. The methods of FIG. 26-FIG. 29 may, but need not, be implemented in the architecture of FIG. 1, using the system of FIG. 2, and represented in illustrative user interfaces and scenarios of FIG. 3-FIG. 25. For ease of explanation, methods 2600-2900 are described with reference to FIG. 1-FIG. 25. However, the methods 2600-2900 may alternatively be implemented in other environments and/or using other systems.

Methods 2600-2900 are described in the general context of computer-executable instructions. Generally, computer-executable instructions can include routines, programs, objects, components, data structures, procedures, modules, functions, and the like that perform particular functions or implement particular abstract data types. The methods can also be practiced in a distributed computing environment where functions are performed by remote processing devices that are linked through a communication network. In a distributed computing environment, computer-executable instructions may be located in local and/or remote computer storage media, including memory storage devices.

The exemplary methods are illustrated as a collection of blocks in a logical flow graph representing a sequence of operations that can be implemented in hardware, software, firmware, or a combination thereof. The order in which the method blocks are described and claimed is not intended to be construed as a limitation, and any number of the described method blocks can be combined in any order to implement the method, or alternate methods. Additionally, individual blocks may be omitted from the method without departing from the spirit and scope of the subject matter described herein. In the context of software, the blocks represent computer instructions that, when executed by one or more processors, perform the recited operations. In the context of hardware, some or all of the blocks may represent application specific integrated circuits (ASICs) or other physical components that perform the recited operations.

FIG. 26 is a flowchart depicting an example method 2600 of evaluating a patent and/or a patent application using a plurality of scoring algorithms. At block 2602, the IP-based business intelligence service 102 may receive information of a patent and/or a patent application from a user 106 for evaluating the patent and/or the patent application. The user 106 may provide information of the patent and/or the patent application to the IP-based business intelligence service 102 through the patent DNA lens, for example, as illustrated in FIG. 3. In one implementation, the user 106 may provide identifying information such as an application number, a publication number or a patent number to the IP-based business intelligence service 102 for identifying the patent or patent application. Alternatively, the user 106 may select the patent or patent application to be evaluated from a list of one or more such documents presented to the user (e.g., as search results, as a portfolio of a patent owner, as documents in a classification of a taxonomy, etc.).

At block 2604, the IP-based business intelligence service 102 may present a user interface enabling the user to select one or more scoring algorithms to use to score the patent and/or patent application from a group of available scoring algorithms. The group of scoring algorithms may include, but is not limited to, a claim scope algorithm (as provided through the claim scope engine 220), a claim signature algorithm, a forward citation algorithm, a backward citation algorithm, a combination of forward and backward citation algorithm, a maintenance fee payment algorithm, a file wrapper history algorithm, etc. The user 106 may select one or more scoring algorithms to evaluate the patent and/or the patent application that are of interest to the user 106. Additionally or alternatively, in some implementations, the IP-based business intelligence service 102 may select at least two scoring algorithms as a default for evaluating the quality of any patent and/or patent application.

At block 2606, the IP-based business intelligence service 102 receives a selection of a plurality of scoring algorithms from the group of available scoring algorithms. In this example, each selected scoring algorithm is based on a different characteristic of the patent or patent application.

At block 2608, the IP-based business intelligence service 102 may evaluates the patent and/or the patent application using the selected scoring algorithms. At block 2610, the IP-based business intelligence service 102 presents the evaluation results of the selected scoring algorithms to the user 106 via a user interface, such as one of the illustrative user interfaces as described above. In some implementations, the IP-based business intelligence service 102 may present results of the plurality of scoring algorithms as composite score by, for example, taking a weighted average of scores of the plurality of scoring algorithms. In some implementations, the IP-based business intelligence service 102 may present a plurality of scoring results, each scoring result being based on a different scoring algorithm (i.e., present four scoring results if four scoring algorithms were selected). FIG. 25 illustrates an example in which both a composite score as well as individual scores are presented.

At block 2612, the IP-based business intelligence service 102 may allow the user 106 to select other scoring algorithms from the group of scoring algorithms. In response to receiving a user selection of a new set of scoring algorithms, the IP-based business intelligence service 102 may perform the evaluation of the quality of the patent or the patent application using the new set of scoring algorithms, and update or display the evaluation results (and/or the combined evaluation score) of the patent or the patent application via the user interface.

FIG. 27 is a flowchart depicting an example method 2700 of determining a scope metric of a claim of a patent or a patent application. At block 2702, the IP-based business intelligence service 102 receives identifying information of a patent and/or a patent application from a user 106 for which the user desires to evaluate a claim scope of the patent or patent application. For example, the user 106 may want to know the claim scope of a claim of the patent or the patent application as compared to other patents and/or patent applications of the same technological field. In one implementation, the IP-based business intelligence service 102 may receive identifying information (such as an application number, a publication number or a patent number) of the patent or patent application of interest to the user 106. The user 106 may provide information of the patent and/or the patent application to the IP-based business intelligence service 102 through the patent DNA lens, for example, as illustrated in FIG. 3. Alternatively, the user 106 may select the patent or patent application to be evaluated from a list of one or more such documents presented to the user (e.g., as search results, as a portfolio of a patent owner, as documents in a classification of a taxonomy, etc.).

At block 2704, upon receiving the identifying information of the patent or the patent application of interest to the user 106, the IP-based business intelligence service 102 may evaluate the claim relative to other claims of a collection of one or more other patents and/or patent applications to produce a scope metric of the claim, such as the ClaimScape™ metrics shown in FIGS. 19, 20, 24, and 25, for example. The collection of patents or patent applications may be defined by, for example, a portfolio of a patent owner, a classification of a taxonomy (e.g., public taxonomy such as a classification system of a patent office or governmental agency, a private taxonomy such as a taxonomy for a private company, a taxonomy set by a standards body or an industry, etc.), results of a search, or any other collection of patent documents. In one example, the scope metric may be based on a first premise that claims that use fewer unique words are broader than claims that use more unique words, and a second premise that claims that use more commonly used words in the collection tend to be broader than claims that use less commonly used words in the collection. More specifically, the IP-based business intelligence service 102 may evaluate the claim of the patent or patent application by, at block 2706, determining a number of unique words in the claim, and at block 2708, determining how frequently each unique word of the claim appears in all claims in all patents and patent applications in the collection.

At block 2710, upon determining the scope metric of the claim of the patent or the patent application, the IP-based business intelligence service 102 may present the scope metric of the claim to the user 106 via a user interface. For example, the IP-based business intelligence service 102 may present a designator of the claim within a graphical area to represent the scope metric of the claim relative to scope metrics of the other claims as illustrated in FIGS. 19, 20, 24, and 25. For example, the IP-based business intelligence service 102 may present the designator of the claim within the graphical area on a two dimensional graph in which a first axis of the graph represents the first premise of the scoring algorithm and a second axis of the graph represents the second premise of the scoring algorithm.

FIG. 28 is a flowchart depicting an example method 2800 of performing a concept search for patents and/or patent applications based on a taxonomy selected from multiple available taxonomies. At block 2802, the IP-based business intelligence service 102 receives a textual description as an input query from the user 106. The input query may include textual description (e.g., a complete or incomplete sentence, a complete or incomplete paragraph, text of a claim, a product description, a document, etc.) of one or more concepts.

Additionally or alternatively, the IP-based business intelligence service 102 may, at block 2804, receive selection of a taxonomy from a plurality of available taxonomies. The taxonomy may comprise a public taxonomy such as a classification system of a patent office or governmental agency, a private taxonomy such as a taxonomy for a private company, a taxonomy set by a standards body or an industry, or the like.

Upon receiving the textual description and/or selection of the taxonomy, at block 2806, the IP-based business intelligence service 102 determines one or more concepts for which to search based on the textual description and/or the selected taxonomy. In one implementation, the IP-based business intelligence service 102 may employ LSI technology to determine or identify the one or more concepts for which to search from the textual description.

At block 2808, the IP-based business intelligence service 102 performs a search of a corpus of patent documents, based on the one or more concepts, for one or more patent documents relevant to the determined concept(s). For example, the IP-based business intelligence service 102 may employ the concept search engine 120 to identify one or more patent documents (e.g., issued patents and/or published patent applications) that include the same or substantially similar concepts as determined in the textual description or are relevant to the one or more determined concepts of the textual description.

At block 2810, the IP-based business intelligence service 102 may return search results including one or more patents or patent applications arranged in accordance with a plurality of classifications of the selected taxonomy. At block 2812, the IP-based business intelligence service 102 may present the search results to the user 106 via a user interface (such as the illustrative user interfaces as shown in FIG. 5 and FIG. 6, for example). In one implementation, the IP-based business intelligence service 102 may present search results via the user interface in a graphical form, a tabular form and/or a list form. Additionally or alternatively, the IP-based business intelligence service 102 may present a search results page in which results from the search are presented on a scatter plot having relevance of results plotted along one axis and time plotted along a second axis. In some implementations, each of the search results may include a visual indication of whether the respective search result is an issued patent or a published patent application. For example, an issued patent may be represented as a diamond while a published patent application may be represented as a circle in the scatter plot.

Depending on the type of search, different patent documents may be found and presented in the user interface. For example, the user 106 may return to block 2804 to select another taxonomy dividing the corpus of documents differently, potentially according to different concepts or criteria. In that case, the IP-based business intelligence service 102 may rerun the search and provide different results to the user 106 and/or provide the results in a different format or order.

At block 2814, the IP-based business intelligence service 102 may receive a selection of a control on a menu of the search results page. In response to receiving a selection of the control, the IP-based business intelligence service 102 may present a different view or information related to the patent documents found in this search based on the type of the selected control on the menu. In one example, at block 2816, the IP-based business intelligence service 102 may present a distribution of owners of patent documents included in the search results (e.g., as shown in FIG. 7). For another example, upon receiving a selection of a control for displaying classifications for the found patent documents, the IP-based business intelligence service 102 may present the found patent documents under separate classifications based on a predetermined or user-selected taxonomy including system, a patent classification, a publicly available taxonomy, or a private taxonomy for a company.

FIG. 29 is a flowchart depicting an example method 2900 of determining and analyzing a patent portfolio of a patent owner or assignee. At block 2902, the IP-based business intelligence service 102 may receive selection of a collection of patent documents. For example, the IP-based business intelligence service 102 may receive information of a patent owner indicating selection of a collection of patent documents in a portfolio of the patent owner. As another example, the IP-based business intelligence service 102 may receive selection of a classification of a taxonomy defining the collection of patent documents. The taxonomy may be selected from among a plurality of available taxonomies presented to the user 106 including one or more taxonomies used by patent offices of one or more countries, one or more taxonomies used by one or more international or national organizations, one or more taxonomies customized for one or more companies, one or more technologies, and/or one or more industries, etc. In still another example, the selection of the collection of patent documents may amount to performing a concept and/or keyword search selecting the search results as the collection of patent documents. In some examples, the IP-based business intelligence service 102 may receive multiple inputs defining the collection of patent documents (e.g., information of a patent owner, as well as selection of a taxonomy classification).

At block 2904, the IP-based business intelligence service 102 determines one or more bounds on the collection of patent documents (e.g., one or more intellectual property owners, taxonomy classifications, technology sectors, etc.) based on user input (e.g., a search query), based on user selection of a taxonomy classification, based on a top N entries in the collection, etc.

At block 2906, the IP-based business intelligence service 102 may in some implementations expand the search query to include additional information (e.g., common misspellings, abbreviations, divisions, subsidiaries, parent entity, acquisitions, alternative names, alternative classifications, cross references, synonyms, etc.). In this way, the IP-based business intelligence service 102 captures relevant documents that otherwise might be missed.

At block 2908, the system may, in some implementations, present information about the collection (e.g., statistics, tables, graphics, etc.). Several example user interfaces that may be used to present such information to a user are as shown in FIGS. 12-17. From this information about the collection (e.g., from an interface such as those shown in FIGS. 12-17) or from a search results page, a user may select one or more claims of a patent or patent application of the collection of patent documents.

At block 2910, the IP-based business intelligence service 102 receives selection of the claim of the patent or patent application of the collection of patent documents and, at block 2912, presents a claim signature of the claim. In one example, the claim signature comprises a graphical representation of the claim as a plurality of bars, each bar representing a word in the claim and a length of each bar being sized according to a number of times that the word represented by the bar appears in a group of claims in the collection of patent documents. For example, the group of claims in the collection of patent documents may comprise all claims that appear in the collection of patent documents, all independent claims that appear in the collection of patent documents, all claims that appear in the collection of patent documents and belong to a same statutory class of the claim associated with the claim signature, or all independent claims that appear in the collection of patent documents and belong to a same statutory class of the claim associated with the claim signature. FIGS. 21-25 illustrate several examples of how the claim signature may be presented on a user interface.

### CONCLUSION

Although the subject matter has been described in language specific to structural features, it is to be understood that the subject matter defined in the appended claims is not necessarily limited to the specific features described. Rather, the specific features are disclosed as illustrative forms of implementing the claims.

What is claimed is:

1. A method of analyzing intellectual property information, the method comprising:
under control of one or more processors configured with executable instructions:
receiving selection of a classification of a taxonomy;
determining one or more intellectual property owners; and
presenting information of a portion of an intellectual property portfolio of the one or more intellectual property owners according to the selected classification.

2. The method of claim 1, wherein the determining of the one or more intellectual property owners comprises receiving input of the one or more intellectual property owners via a user interface.

3. The method of claim 1, wherein the determining of the one or more intellectual property owners comprises identifying a top N number of intellectual property owners of intellectual property assets in the classification, where N is an integer greater than or equal to one.

4. The method of claim 3, wherein the top N number of intellectual property owners is a predetermined default number.

5. The method of claim 3, wherein the top N number of intellectual property owners is selectable by a user.

6. The method of claim 1, wherein the taxonomy comprises:
a taxonomy used by a patent office of a country,
a taxonomy used by an international organization, or
a taxonomy of a private company.

7. The method of claim 1, wherein the presenting information of a portion of an intellectual property portfolio of the one or more intellectual property owners comprises:
presenting statistics about the intellectual property portfolio of the one or more intellectual property owners including, for each intellectual property owner:
a total number of pending patent applications attributable to the respective intellectual property owner;
a total number of issued patents attributable to the respective intellectual property owner
a total number of unexpired, issued patents attributable to the respective intellectual property owner;
a mean age of issued patents attributable to the respective intellectual property owner;
a mean age of unexpired, issued patents attributable to the respective intellectual property owner;
an anticipated number of patents attributable to the respective intellectual property owner that will expire in the next year;
a rate of change of pending patent applications attributable to the respective intellectual property owner;
a rate of change of issued patents attributable to the respective intellectual property owner;
a rate of change of issued, unexpired patents attributable to the respective intellectual property owner;
a mean number of independent claims in patents and/or patent applications attributable to the respective intellectual property owner;
a mean number of total claims in patents and/or patent applications attributable to the respective intellectual property owner; and/or
a mean number of words in independent claims of patents and/or patent applications attributable to the respective intellectual property owner.

8. The method of claim 1, further comprising:
receiving selection of an intellectual property owner from the one or more intellectual property owners; and
presenting an indication of a number of intellectual property assets owned by the intellectual property owner in the selected classification in each of a top M subclasses of the classification, where M is an integer greater than or equal to one.

9. The method of claim 1, wherein the presenting information of a portion of an intellectual property portfolio of the one or more intellectual property owners comprises presenting the information in a tabular format, a graphical format, or both.

10. The method of claim 1, further comprising:
receiving selection of a claim of a patent or patent application in the intellectual property portfolio of the intellectual property owner; and
presenting a claim signature comprising a graphical representation of the claim as a plurality of bars, wherein each bar represents a word in the claim and a length of each bar is sized according to a number of times that the words appears in all claims in the classification.

11. A method of analyzing an intellectual property portfolio, the method comprising:
under control of one or more processors configured with executable instructions:
receiving a search query including information of an intellectual property owner;
expanding the search query to include additional information; and
presenting, based on the information of the intellectual property owner and the additional information, information of an intellectual property portfolio of the intellectual property owner according to a predetermined order.

12. The method of claim 11, wherein the information of the intellectual property owner comprises a name and/or an address of the intellectual property owner.

13. The method of claim 11, wherein the additional information comprises common misspellings of the intellectual property owner, abbreviations of the intellectual property owner, divisions of the intellectual property owner, subsidiaries of the intellectual property owner, a parent entity of the intellectual property owner, acquisitions by the intellectual property owner, and/or alternative names of the intellectual property owner.

14. The method of claim 11, wherein the intellectual property portfolio of the intellectual property owner comprises one or more patents and/or patent applications associated with the intellectual property owner.

15. The method of claim 11, wherein the predetermined order comprises an ordering by inventors, an ordering by dates, and/or an ordering according to a predetermined taxonomy.

16. The method of claim 11, further comprising:
receiving a selection of a taxonomy classifying patents and/or patent applications into a plurality of classifications, wherein the presenting comprises presenting the information of the intellectual property portfolio of the intellectual property owner according to the taxonomy.

17. The method of claim 16, wherein the presenting further comprises:
presenting respective numbers of patents and/or patent applications of the intellectual property owner under one or more classifications of the taxonomy; and/or
presenting respective percentages of the patents and/or the patent applications of the intellectual property owner under the one or more classifications of the taxonomy relative to a total number of patents and/or patent applications owned by the intellectual property owner.

18. The method of claim 17, further comprising:
receiving a selection of a classification from the one or more classifications;
presenting additional information of the intellectual property portfolio under one or more sub-classifications of the selected classification, presenting the additional information comprising:
presenting respective numbers of patents and/or patent applications of the intellectual property owner under the one or more sub-classifications; and/or
presenting respective percentages of the patents and/or the patent applications of the intellectual property owner under the one or more sub-classifications relative to the total number of patents and/or patent applications owned by the intellectual property owner.

19. The method of claim 11, further comprising performing a search for patents and/or patent applications based on the information of the intellectual property owner, and returning search results including one or more patents and/or patent applications.

20. The method of claim 11, further comprising:
receiving selection of a claim of a patent or patent application in the intellectual property portfolio of the intellectual property owner; and
presenting a claim signature comprising a graphical representation of the claim as a plurality of bars, wherein each bar represents a word in the claim and a length of each bar is sized according to a number of times that the words appears in all claims in the intellectual property portfolio of the intellectual property owner.

21. A system comprising:
one or more processors; and
memory storing one or more modules executable by the one or more processors to perform acts comprising:
receiving selection of a collection of patent documents;
receiving selection of a claim of a patent or patent application of the collection of patent documents; and
presenting a claim signature of the claim, the claim signature comprising a graphical representation of the claim as a plurality of bars, wherein each bar represents a word in the claim and a length of each bar is sized according to a number of times that the word represented by the bar appears in a group of claims in the collection of patent documents.

22. The system of claim 21, wherein the group of claims in the collection of patent documents comprises:
all claims that appear in the collection of patent documents;
all independent claims that appear in the collection of patent documents;
all claims that appear in the collection of patent documents and belong to a same statutory class of the claim associated with the claim signature; or
all independent claims that appear in the collection of patent documents and belong to a same statutory class of the claim associated with the claim signature.

23. The system of claim 21, wherein the collection of patent documents comprises a portfolio of a patent owner.

24. The system of claim 21, wherein the collection of patent documents comprises a classification of a taxonomy.

25. The system of claim 24, wherein the taxonomy comprises:
a taxonomy used by a patent office of a country,
a taxonomy used by an international organization, or
a taxonomy of a private company.

26. The system of claim 21, wherein the group of claims in the collection of patent documents comprises a plurality of words, and the acts further comprise presenting the plurality of words in a descending order of respective commonness or frequencies.

27. The system of claim 21, the acts further comprising employing color coding to show different percentile ranges of commonness or frequencies of words appearing in the group of claims of the collection of patent documents.

28. The system of claim 21, the acts further comprising a control to allow a user to select a claim from one or more claims within the patent or application.

29. The system of claim 28, the acts further comprising presenting a textual description of the selected claim in response to detecting selection of an icon adjacent to the control.

30. The system of claim 21, the acts further comprising:
presenting a plurality of word clouds,
a first cloud of the plurality of word clouds showing top N words that are commonly found in the group of claims of the collection of patent documents, and
a second word cloud of the plurality of word clouds showing top M words that are most frequently used within the claim associated with the claim signature,
wherein N and M are integers greater than or equal to one, and wherein values of N and M are selectable by the user or predefined by the system.
